(19) United States
(12) Patent Application Publication
(10) Pub. No.: US 2026/0162036 A1
(43) Pub. Date: Jun. 11, 2026

(54) ARTIFICIAL INTELLIGENCE-BASED WORKFORCE MANAGEMENT SYSTEMS, METHODS, AND MEDIA

(71) Applicant: Pearson Education, Inc., Bloomington, MN (US)

(72) Inventors: Blair HUDSON, Alexandria (AU); Catriona Teresa MIRIKLIS, Cape Paterson (AU); Sandya Gillian BARATHA RAJ, Alexandria (AU)

(21) Appl. No.: 19/179,315

(22) Filed: Apr. 15, 2025

Related U.S. Application Data
(60) Provisional application No. 63/634,182, filed on Apr. 15, 2024.

(51) Int. Cl. G06Q 10/0631; G06Q 10/0639

(52) U.S. Cl. CPC G06Q 10/06316; G06Q 10/06398

(57) ABSTRACT

Systems, methods, and media pertaining to workforce management can leverage an ontology to appropriately model and define various aspects of a workforce, thereby providing a globally unique platform for the assessment, development, and alignment of both human and artificial intelligence skillsets. The workforce management systems, methods, and media can be used to balance human and machine learning capabilities and accelerate productivity in a variety of applications.

### CROSS-REFERENCE TO RELATED APPLICATION

This application claims the benefit of and priority to U.S. Provisional Patent Application No. 63/634,182, filed April 15, 2024, the entirety of which is incorporated by reference herein.

### TECHNICAL FIELD

The disclosure relates to systems, methods, and media for workforce management. More particularly, the disclosure relates to systems, methods, and media that can be used to help various organizations incorporate emerging technologies including artificial intelligence.

### BRIEF DESCRIPTION OF THE DRAWINGS

FIG. 1 is a block diagram showing components of an example distributed computing environment, in accordance with some aspects of the disclosure.

FIG. 2 is a block diagram showing components of an example computing system, in accordance with some aspects of the disclosure.

FIG. 3 is a block diagram showing components of an example workforce management system, in accordance with some aspects of the disclosure.

FIG. 4 is a flowchart showing an example process for workforce management, in accordance with some aspects of the disclosure.

FIG. 5 is a flowchart showing another example process for workforce management, in accordance with some aspects of the disclosure.

FIG. 6 is a flowchart showing yet another example process for workforce management, in accordance with some aspects of the disclosure.

FIG. 7 is a flowchart showing a further example process for workforce management, in accordance with some aspects of the disclosure.

FIG. 8 is a flowchart showing a still further example process for workforce management, in accordance with some aspects of the disclosure.

FIG. 9 is an example skills proficiency user interface that can be provided by the system of FIG. 3, in accordance with some aspects of the disclosure.

FIG. 10 is an example table showing questions for skills proficiency assessments that can be provided by the system of FIG. 3, in accordance with some aspects of the disclosure.

FIG. 11 is an example table showing associations as part of a task-skills framework that can be implemented in the system of FIG. 3, in accordance with some aspects of the disclosure.

FIG. 12 is an example table showing associations as part of a task-based process model that can be implemented in the system of FIG. 3, in accordance with some aspects of the disclosure.

FIG. 13 is an example table showing associations as part of a tech taxonomy that can be implemented in the system of FIG. 3, in accordance with some aspects of the disclosure.

FIG. 14 is an example table showing additional associations as part of the tech taxonomy that can be implemented in the system of FIG. 3, in accordance with some aspects of the disclosure.

FIG. 15 is an example table showing data associated with different artificial intelligence models that can be maintained by the system of FIG. 3, in accordance with some aspects of the disclosure.

FIG. 16 is an example table showing additional data associated with different artificial intelligence models that can be maintained by the system of FIG. 3, in accordance with some aspects of the disclosure.

### DETAILED DESCRIPTION

The disclosed technology will now be discussed in detail with regard to the attached drawing figures that were briefly described above. In the following description, numerous specific details are set forth illustrating the Applicant’s best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

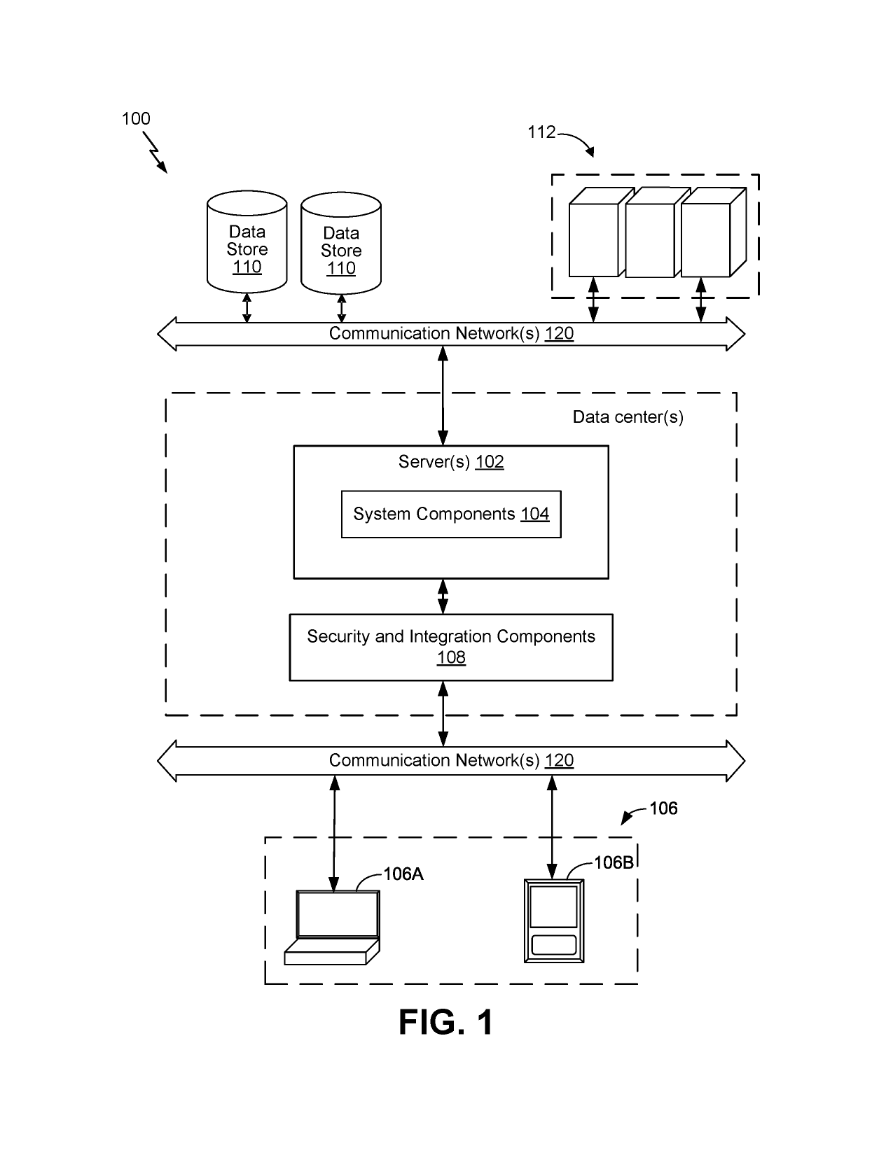

Referring to FIG. 1, a non-limiting example of a distributed computing environment 100 is shown, in accordance with some aspects of the disclosure. In some examples, the distributed computing environment 100 may include one or more server(s) 102 (e.g., data servers, computing devices, computers, etc.), one or more client computing devices 106, and/or other components that may implement certain embodiments and features described herein. Other devices, such as specialized sensor devices, etc., may interact with the client computing device(s) 106 and/or the server(s) 102. The server(s) 102, client computing device(s) 106, or any other devices may be configured to implement a client-server model or any other distributed computing architecture. In an illustrative and non-limiting example, the client devices 106 may include a first client device 106A and a second client device 106B. The first client device 106A may correspond to a first user in a class and the second client device 106B may correspond to a second user in the class or another class. In some examples, the client devices 106 can include a virtual reality headset or any suitable computing device with a display (e.g., smartphone, tablet, laptop computer, etc.).

In some examples, the server(s) 102, the client computing device(s) 106, and any other disclosed devices may be communicatively coupled via one or more communication network(s) 120. The communication network(s) 120 may be any type of communication networks supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as, e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like, or any successor protocols.

The examples shown in FIGS. 1 and/or 2 are respective examples of a distributed computing system and are not intended to be limiting. The subsystems and components within the server(s) 102 and the client computing device(s) 106 may be implemented in hardware, firmware, software, or combinations thereof. Various different subsystems and/or components 104 may be implemented on the server 102. Users operating the client computing device(s) 106 may initiate one or more client applications to use services provided by these subsystems and components. Various different system configurations are possible in different types of distributed computing environments and content distribution networks. Server 102 may be configured to run one or more server software applications or services, for example, web-based or cloud-based services, to support content distribution and interaction with client computing device(s) 106. Users operating client computing device(s) 106 may in turn utilize one or more client applications (e.g., virtual client applications) to interact with server 102 to utilize the services provided by these components. The client computing device(s) 106 may be configured to receive and execute client applications over the communication network(s) 120. Such client applications may be web browser-based applications and/or standalone software applications, such as mobile device applications. The client computing device(s) 106 may receive client applications from server 102 or from other application providers (e.g., public or private application stores).

As shown in FIG. 1, various security and integration components 108 may be used to manage communications over the communication network(s) 120 (e.g., a file-based integration scheme, a service-based integration scheme, etc.). In some examples, the security and integration components 108 may implement various security features for data transmission and storage, such as authenticating users or restricting access to unknown or unauthorized users. As non-limiting examples, the security and integration components 108 may include any dedicated hardware, specialized networking components, and/or software (e.g., web servers, authentication servers, firewalls, routers, gateways, load balancers, etc.) within one or more data centers in one or more physical location(s) and/or operated by one or more entities, and/or may be operated within a cloud infrastructure. In various implementations, the security and integration components 108 may transmit data between the various devices in the distribution computing environment 100 (e.g., in a content distribution system or network). In some examples, the security and integration components 108 may use secure data transmission protocols and/or encryption (e.g., File Transfer Protocol (FTP), Secure File Transfer Protocol (SFTP), and/or Pretty Good Privacy (PGP) encryption) for data transfers, etc.).

In some examples, the security and integration components 108 may implement one or more web services (e.g., cross-domain and/or cross-platform web services) within the distribution computing environment 100, and may be developed for enterprise use in accordance with various web service standards (e.g., the Web Service Interoperability (WS-I) guidelines). In an example, some web services may provide secure connections, authentication, and/or confidentiality throughout the network using technologies such as SSL, TLS, HTTP, HTTPS, WS-Security standard (providing secure SOAP messages using XML encryption), etc. In some examples, the security and integration components 108 may include specialized hardware, network appliances, and the like (e.g., hardware-accelerated SSL and HTTPS), possibly installed and configured between one or more server(s) 102 and other network components. In such examples, the security and integration components 108 may thus provide secure web services, thereby allowing any external devices to communicate directly with the specialized hardware, network appliances, etc.

The distributed computing environment 100 may further include one or more data stores 110. In some examples, the one or more data stores 110 may include, and/or reside on, one or more back-end servers 112, operating in one or more data center(s) in one or more physical locations. In such examples, the one or more data stores 110 may communicate data between one or more devices, such as those connected via the one or more communication network(s) 120. In some cases, the one or more data stores 110 may reside on a non-transitory storage medium within one or more server(s) 102. In some examples, data stores 110 and back-end servers 112 may reside in a storage-area network (SAN). In addition, access to one or more data stores 110, in some examples, may be limited and/or denied based on the processes, user credentials, and/or devices attempting to interact with the one or more data stores 110.

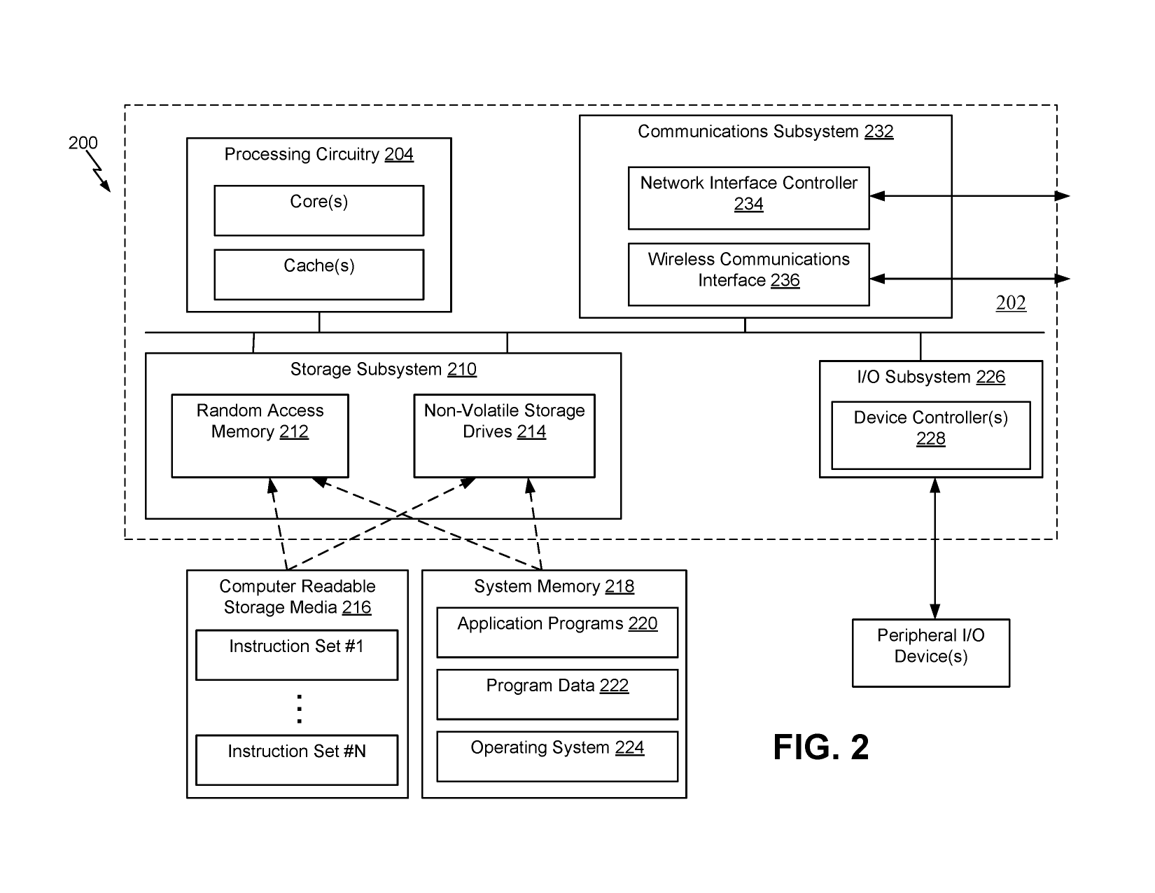

Referring to FIG. 2, a block diagram of an example computing system 200 is shown, in accordance with some aspects of the disclosure. The computing system 200 (e.g., one or more connected computers) may correspond to any one or more of the computing devices or servers of the distributed computing environment 100, or any other computing devices described herein. In an example, the computing system 200 may represent an example of one or more server(s) 102 and/or of one or more server(s) 112 of the distributed computing environment 100. In another example, the computing system 200 may represent an example of the client computing device(s) 106 of the distributed computing environment 100. In some examples, the computing system 200 may represent a combination of one or more computing devices and/or servers of the distributed computing environment 100.

In some examples, the computing system 200 may include processing circuitry 204, such as one or more processing unit(s), processor(s), etc. In some examples, the processing circuitry 204 may communicate (e.g., interface) electronically with a number of peripheral subsystems via a bus subsystem 202. These peripheral subsystems may include, for example, a storage subsystem 210, an input/output (I/O) subsystem 226, and a communications subsystem 232.

In some examples, the processing circuitry 204 may be implemented as one or more integrated circuits (e.g., a micro-processor or microcontroller). In an example, the processing circuitry 204 may control the operation of the computing system 200. The processing circuitry 204 may include single core and/or multicore (e.g., quad core, hexa-core, octo-core, ten-core, etc.) processors and processor caches (e.g., central processing units (CPUs), graphics processing units (GPUs), etc.). The processing circuitry 204 may execute a variety of resident software processes embodied in program code, and may maintain multiple concurrently executing programs or processes. In some examples, the processing circuitry 204 may include one or more specialized processors, (e.g., digital signal processors (DSPs), outboard, graphics application-specific, and/or other processors).

In some examples, the bus subsystem 202 provides a mechanism for intended communication between the various components and subsystems of computing system 200. Although the bus subsystem 202 is shown schematically as a single bus, alternative embodiments of the bus subsystem may utilize multiple buses. In some examples, the bus subsystem 202 may include a memory bus, memory controller, peripheral bus, and/or local bus using any of a variety of bus architectures (e.g., Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard, etc.).

In some examples, the I/O subsystem 226 may include one or more device controller(s) 228 for one or more user interface input devices and/or user interface output devices, possibly integrated with the computing system 200 (e.g., virtual reality headsets, integrated audio/video systems, and/or touchscreen displays), or may be separate peripheral devices which are attachable/detachable from the computing system 200. Input may include keyboard or mouse input, audio input (e.g., spoken commands), motion sensing, gesture recognition (e.g., eye gestures), etc. As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like. In general, use of the term “output device” is intended to include all possible types of devices and mechanisms for outputting information from computing system 200, such as to a user (e.g., via a display device) or any other computing system, such as a second computing system 200. In an example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or may include one or more non-visual display subsystems and/or non-visual display devices, such as audio output devices, etc. As non-limiting examples, output devices may include, virtual reality headsets, indicator lights, monitors, printers, speakers, headphones, automotive navigation systems, plotters, voice output devices, modems, etc.

In some examples, the computing system 200 may include one or more storage subsystems 210, including hardware and software components used for storing data and program instructions, such as system memory 218 and computer-readable storage media 216. In some examples, the system memory 218 and/or the computer-readable storage media 216 may store and/or include program instructions (e.g., a set of N Instruction Sets) that are loadable and executable on the processor(s) 204. In an example, the system memory 218 may load and/or execute an operating system 224, program data 222, server applications, application program(s) 220 (e.g., client applications), Internet browsers, mid-tier applications, etc. In some examples, the system memory 218 may further store data generated during execution of these instructions.

In some examples, the system memory 218 may be stored in volatile memory (e.g., random-access memory (RAM) 212, including static random-access memory (SRAM) or dynamic random-access memory (DRAM)). In an example, the RAM 212 may contain data and/or program modules that are immediately accessible to and/or operated and executed by the processing circuitry 204. In some examples, the system memory 218 may also be stored in non-volatile storage drives 214 (e.g., read-only memory (ROM), flash memory, etc.). In an example, a basic input/output system (BIOS), containing the basic routines that help to transfer information between elements within the computing system 200 (e.g., during start-up), may typically be stored in the non-volatile storage drives 214.

In some examples, the storage subsystem 210 may include one or more tangible computer-readable storage media 216 for storing the basic programming and data constructs that provide the functionality of some embodiments. In an example, the storage subsystem 210 may include software, programs, code modules, instructions, etc., that may be executed by the processing circuitry 204, in order to provide the functionality described herein. In some examples, data generated from the executed software, programs, code, modules, or instructions may be stored within a data storage repository within the storage subsystem 210. In some examples, the storage subsystem 210 may also include a computer-readable storage media reader connected to the computer-readable storage media 216.

In some examples, the computer-readable storage media 216 may contain program code, or portions of program code. Together and optionally in combination with the system memory 218, the computer-readable storage media 216 may comprehensively represent remote, local, fixed, and/or removable storage devices plus storage media for temporarily and/or more permanently containing, storing, transmitting, and/or retrieving computer-readable information. In some examples, the computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer-readable media. This can also include nontangible computer-readable media, such as data signals, data transmissions, or any other medium which can be used to transmit the desired information, and which can be accessed by the computing system 200. In an illustrative and non-limiting example, the computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media.

In some examples, the computer-readable storage media 216 may include, but is not limited to, Zip® drives, flash memory cards, universal serial bus (USB) flash drives, secure digital (SD) cards, DVD disks, digital video tape, and the like. In some examples, the computer-readable storage media 216 may include, solid-state drives (SSD) based on non-volatile memory such as flash-memory based SSDs, enterprise flash drives, solid state ROM, and the like, SSDs based on volatile memory such as solid-state RAM, dynamic RAM, static RAM, DRAM-based SSDs, magneto-resistive RAM (MRAM) SSDs, and hybrid SSDs that use a combination of DRAM and flash memory-based SSDs. The disk drives and their associated computer-readable media may provide non-volatile storage of computer-readable instructions, data structures, program modules, and other data for the computing system 200.

In some examples, the communications subsystem 232 may provide a communication interface from the computing system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally, and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 232 also may include radio frequency (RF) transceiver components for accessing wireless voice and/or data networks (e.g., using cellular telephone technology, advanced data network technology, such as 3G, 4G, 5G or EDGE (enhanced data rates for global evolution), Wi-Fi (IEEE 802.11 family standards, or other mobile communication technologies, or any combination thereof), global positioning system (GPS) receiver components, and/or other components.

In some examples, the communications subsystem 232 may also receive input communication in the form of structured and/or unstructured data feeds, event streams, event updates, and the like, on behalf of one or more users who may use or access the computing system 200. In an example, the communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, the communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). In some examples, the communications subsystem 232 may output such structured and/or unstructured data feeds, event streams, event updates, and the like to one or more data stores that may be in communication with one or more streaming data source computing systems (e.g., one or more data source computers, etc.) coupled to the computing system 200. The various physical components of the communications subsystem 232 may be detachable components coupled to the computing system 200 via a computer network (e.g., a communication network 120), a FireWire® bus, or the like, and/or may be physically integrated onto a motherboard of the computing system 200. In some examples, the communications subsystem 232 may be implemented in whole or in part by software.

Due to the ever-changing nature of computers and networks, the description of the computing system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

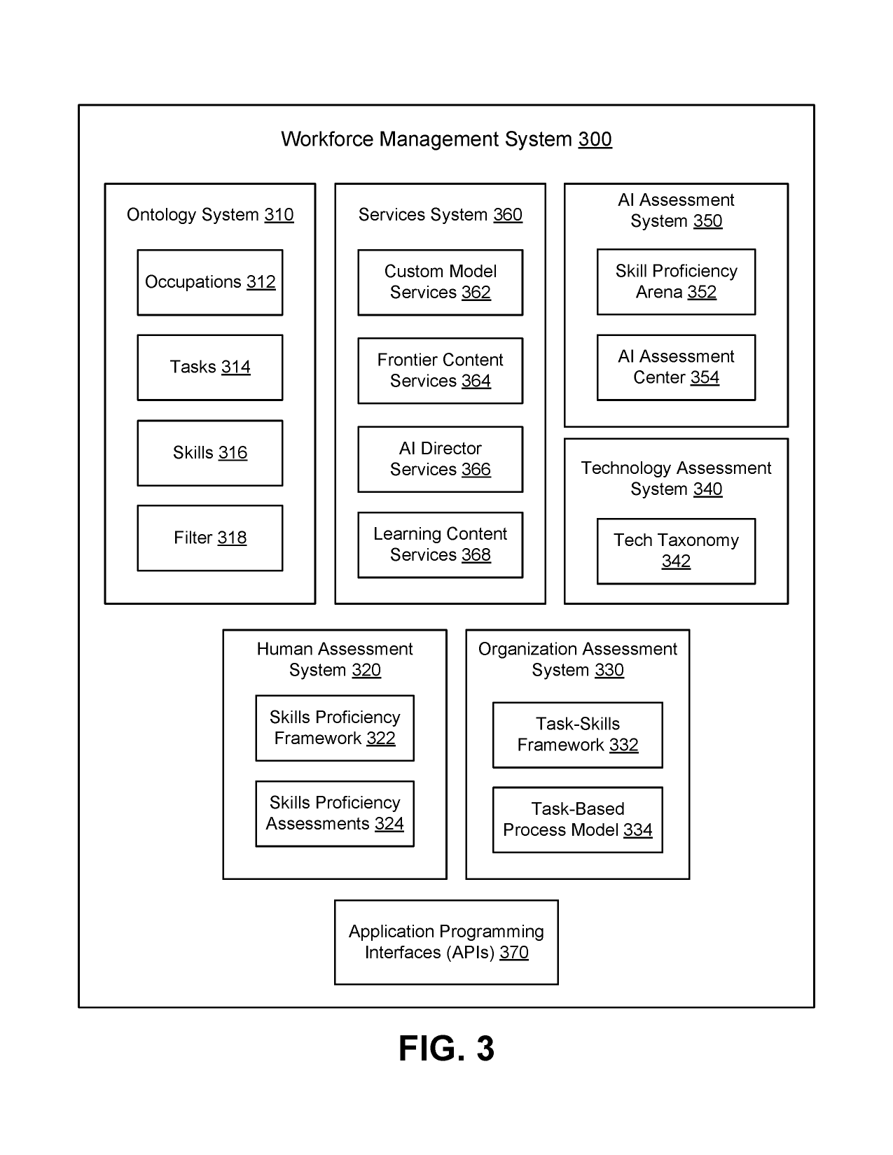

Referring now to FIG. 3, a block diagram showing an example workforce management system 300 is shown, in accordance with some aspects of the disclosure. The example workforce management system 300 can be implemented using a variety of different hardware, software, firmware, and networking configurations, such as, for example, configuration that are similar to those detailed above with respect to the distributed computing environment 100 and the computing system 200. The workforce management system 300 can generally be used to balance human and machine learning capabilities and accelerate productivity in a variety of applications. Existing technologies in the technical fields of workforce management systems and online educational systems currently face a variety of technical challenges in need of solutions. Continued advances in the development of artificial intelligence (AI) technologies create pressures on various types of organizations to successfully adopt these technologies to drive productivity growth and overall operational efficiencies. Organizations face the dual challenge of integrating artificial intelligence technologies while also fostering the development of human workforce skills that are vital for future organizational productivity. The current technological landscape lacks a comprehensive approach to aligning artificial intelligence technologies with human capabilities and development as well as overall organizational performance. As a result, organizations often naively invest in artificial intelligence technologies and human skill enhancement efforts without having a cohesive, strategic plan for doing so.

The workforce management system 300 and its associated functionality can be used to solve these technological challenges in a comprehensive manner. For example, the workforce management system 300 can leverage a carefully designed and tested ontology as detailed below to appropriately model and define various aspects of a workforce, thereby providing a globally unique platform for the assessment, development, and alignment of both human and artificial intelligence skillsets. The workforce management system 300 can also evaluate various artificial intelligence models based on workforce skill proficiencies. Such evaluation can guide technology adoption while simultaneously directing human learning towards future-important areas. For example, the workforce management system 300 can be used to build and train custom yet efficient artificial intelligence models for specifically designed tasks, provide recommendations for learning content, and also provide recommendation for authoring frontier content. The workforce management system 300 can use agentic artificial intelligence to perform any of the functionality detailed below without requiring manual prompting from humans. For example, the workforce management system 300 can grant or enable one or more artificial intelligence models that are implemented in the workforce management system 300 or that are interacted with by the workforce management system 300 (e.g., via the application programming interfaces 370, etc.) to act in an autonomous fashion and perform the any of the functionality detailed below (e.g., any of the steps of the process 400, the process 500, the process 600, the process 700, and the process 800).

The workforce management system 300 is shown to include one or more application programming interfaces (APIs) 370. The application programming interfaces 370 can be used to facilitate provision of various services to external users that desire access to any of the components of the workforce management system 300. The application programming interfaces 370 can include any suitable types of application programming interfaces. For example, the application programming interfaces 370 can include one or more representational state transfer application programming interfaces (REST APIs) and/or other suitable types of application programming interfaces. Various examples of the application programming interfaces 370 that can be provided by the workforce management system 300 are described below. Any of the services described as being provided by the application programming interfaces 370 can additionally or alternatively be performed through various types of user interfaces (e.g., web interfaces, application interfaces, etc.) provided by the workforce management system 300 such that provision of the service does not necessarily require use of an application programming interface. Further, any of the data and/or functionality of the workforce management system 300 may be provided in a proprietary manner such that use of any of the data and/or functionality of the workforce management system 300 may be subject to one or more licensing restrictions.

As shown in FIG. 3, the workforce management system includes an ontology system 310. The ontology system 310 generally provides a data structure that defines and associates various aspects of workforce management. Specifically, the ontology system 310 includes definitions for and relationships between a set of occupations 312, a set of tasks 314, and a set of skills 316. The workforce management system 300 can extract the occupations 312, the tasks 314, and the skills 316 from various types of data. For example, the workforce management system 300 can analyze market data such as, for example, recent job postings available on the Internet and/or can receive job and hiring market data from a variety of other sources. Also, human input (e.g., expert otologist input, recruiter input, etc.) and/or artificial intelligence input (e.g., generative AI input, etc.) can be provided to the workforce management system 300 regarding the occupations 312, the tasks 314, and the skills 316.

The occupations 312 can include occupations such as software engineer, project manager, lawyer, recruiter, and other types of occupations, for example. Each of the occupations 312 can then be associated with one or more of the tasks 314 within the ontology system 310. For example, a teacher occupation can be associated with tasks such as giving lectures, assigning homework, grading papers, and other types of tasks. Further, each of the tasks 314 can then be associated with one or more of the skills 316 within the ontology system 310. For example, a software engineer occupation can be associated with a website maintenance task, and the website maintenance task can be associated with skills such as Java programming, user interface design, and other types of skills needed to perform the task of website maintenance. The ontology system 310 can define thousands, if not hundreds of thousands or more, of each of the occupations 312, the tasks 314, and the skills 316 and their associated relationships. As such, the development and maintenance of the ontology system 310 can require significant effort. However, the ontology system 310 can provide a foundation from which many of the functions of the workforce management system 300 can be built.

The ontology system 310 is also shown to include a filter 318. The filter 318 can be implemented as a “high performance” filter that provides classification of the occupations 312, the tasks 314, and the skills 316 based on industry benchmarks and high performing organizations. Accordingly, use of the filter 318 can provide insight into the top, trending, and emerging skills specifically prevalent among leading organizations in various industries. The approach to defining high performance organizations implemented using the filter 318 can result from a meticulous evaluation of publicly reported data and other data, such as, for example, financial performance data, market share data, innovation rate data, employee satisfaction data, and/or customer feedback data. The filter 318 can be applied within the ontology system 310 to indicate skills mix and proficiency requirements that drive high performance, and then the workforce management system 300 can use this data to align training and skill development to those that drive success.

The workforce management system 300 is also shown to include a human assessment system 320. The human assessment system 320 generally provides functionality to assess and evaluate the performance capabilities of humans with respect to the occupations 312, the tasks 314, and the skills 316. For example, organizations can use the human assessment system 320 to assess the capabilities of personnel in their workforce and/or assess the capabilities of potential candidates for hiring into their workforce by defining and assessing skills through proficiency levels and generated tests. The human assessment system 320 can include both a skills proficiency framework 322 as well as skills proficiency assessments 324. The skills proficiency framework 322 can be designed to provide an in-depth analysis of the skills 316 by categorizing the skills 316 into distinct levels of proficiency. For example, the skills proficiency framework 322 can be designed to categorize the skills 316 into distinct levels of proficiency ranging from novice to expert, or using another scale. Each of the skills 316 in the skills proficiency framework 322 can be accompanied by one or more proficiency statements.

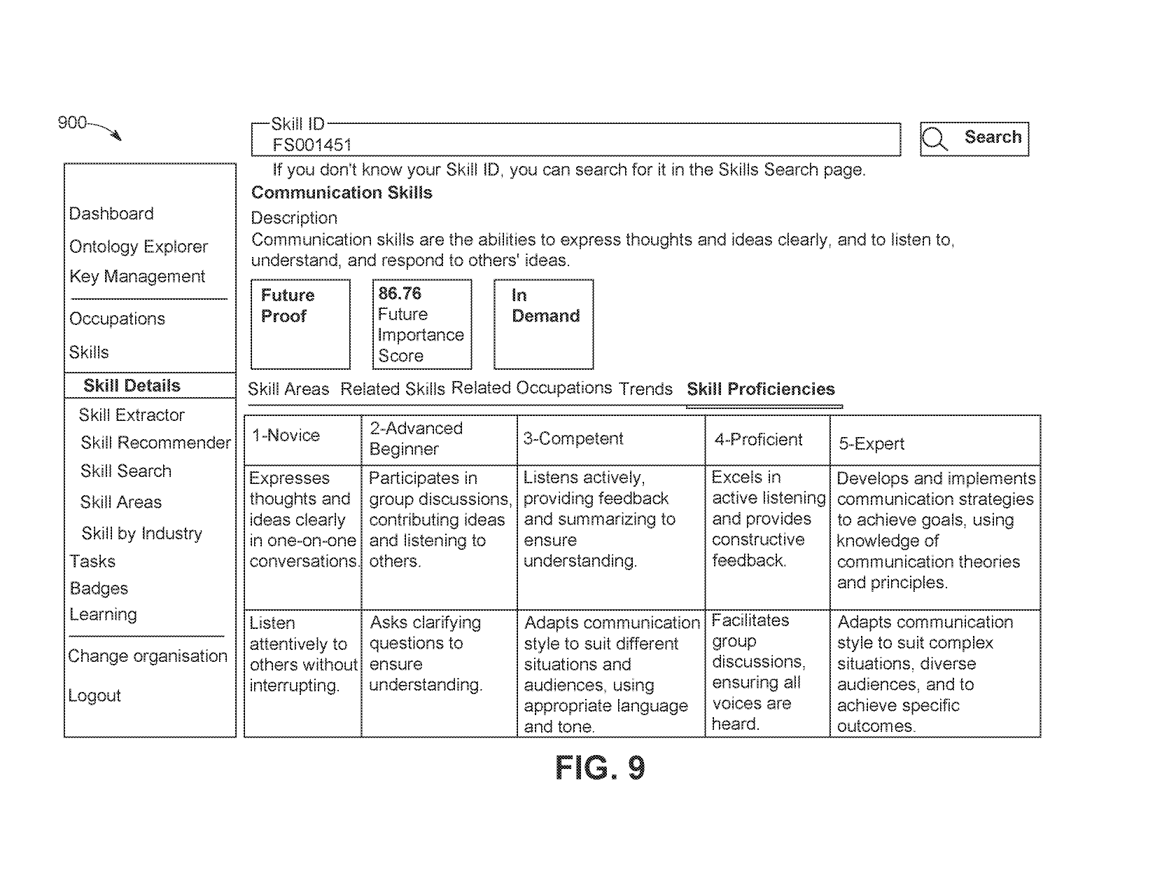

Referring to FIG. 9, an example skills proficiency user interface 900 is shown, in accordance with some aspects of the disclosure. As shown in the skills proficiency user interface 900, a user has selected one of the skills 316, specifically “communication skills” as associated with a particular skill identifier (skill ID) within the ontology system 310. The skills proficiency user interface 900 shows a description of the selected skill, an indication of whether the selected skill is future proof or not (an indication of the likelihood that artificial intelligence will replace the skill), a future importance score for the selected skill (a numerical score indicating the importance of the skill in the future as the adoption of artificial intelligence grows), and an indication of whether the selected skill is in demand in the marketplace or not. Further, the user has selected a “skill proficiencies” tab on the skills proficiency user interface 900, and a series of example proficiency statements associated with different proficiency levels for the selected skill are shown. The skills proficiency framework 322 can define similar proficiency statements for each of the skills 316 defined in the ontology system 310.

The skills proficiency framework 322 can allow the human assessment system 320 to highlight individual learning needs across various proficiency levels and to identify organizational skill gaps at a proficiency level. As a result, the skills proficiency framework 322 can enable individuals and managers to assess key skill requirements across various levels of the occupations 312. The skills proficiency framework 322 can allow the human assessment system 320 to enable comparison of the skills 316 across the occupations 312 side by side to help humans understand which of the skills 316 are important to development goals. For example, the human assessment system 320 can provide guidance for how a human associated with a “data analyst” occupation can develop skills and advance to a “data scientist” occupation.

The application programming interfaces 370 can provide access (e.g., to external users or services) to data associated with the skills proficiency framework 322 in various ways. For example, the application programming interfaces 370 can provide access to the skills proficiency framework 322 with the accompanying proficiency statements for some or all of the skills 316 defined in the ontology system 310. The application programming interfaces 370 can also provide access to the skills proficiency framework 322 with the accompanying proficiency statements for some or all of the skills 316 defined in the ontology system 310 along with expected competency levels for one or more of the occupations 312 defined by the ontology system 310. The application programming interfaces 370 can also provide access to the skills proficiency framework 322 with the accompanying proficiency statements for some or all of the skills 316 defined in the ontology system 310 along with expected competency levels for one or more of the occupations 312 defined by the ontology system 310 across multiple competency levels defined by the skills proficiency framework 322. The application programming interfaces 370 can further provide access to customized analytics and reporting functionality for organizations to assess a workforce based on the skills proficiency framework 322. The application programming interfaces 370 can also provide access to a training module that can be used to train individuals on use of the skills proficiency framework 322.

The skills proficiency assessments 324 can include carefully designed tests and/or other types of assessments that can be provided to humans to evaluate performance capabilities of humans with respect to the skills 316. For example, the skills proficiency assessments 324 can include multiple choice tests and/or other types of tests that can be provided to humans via a user interface on a user device. Based on the answers submitted by humans to the skills proficiency assessments, the human assessment system 320 can generate skill proficiency evaluations for humans that are indicative of the performance capabilities of the humans with respect to the skills 316. The skills proficiency assessments 324 can be carefully designed by subject matter experts and/or other sources (e.g., generative artificial intelligence, etc.) such that the skills proficiency assessments 324 accurately gauge the skill level of humans in various domains associated with the skills 316. Upon successful completion of one or more of the skills proficiency assessments 324, humans can display credentials (e.g., badges, etc.) on a user profile to demonstrate performance capabilities in various domains associated with the skills 316.

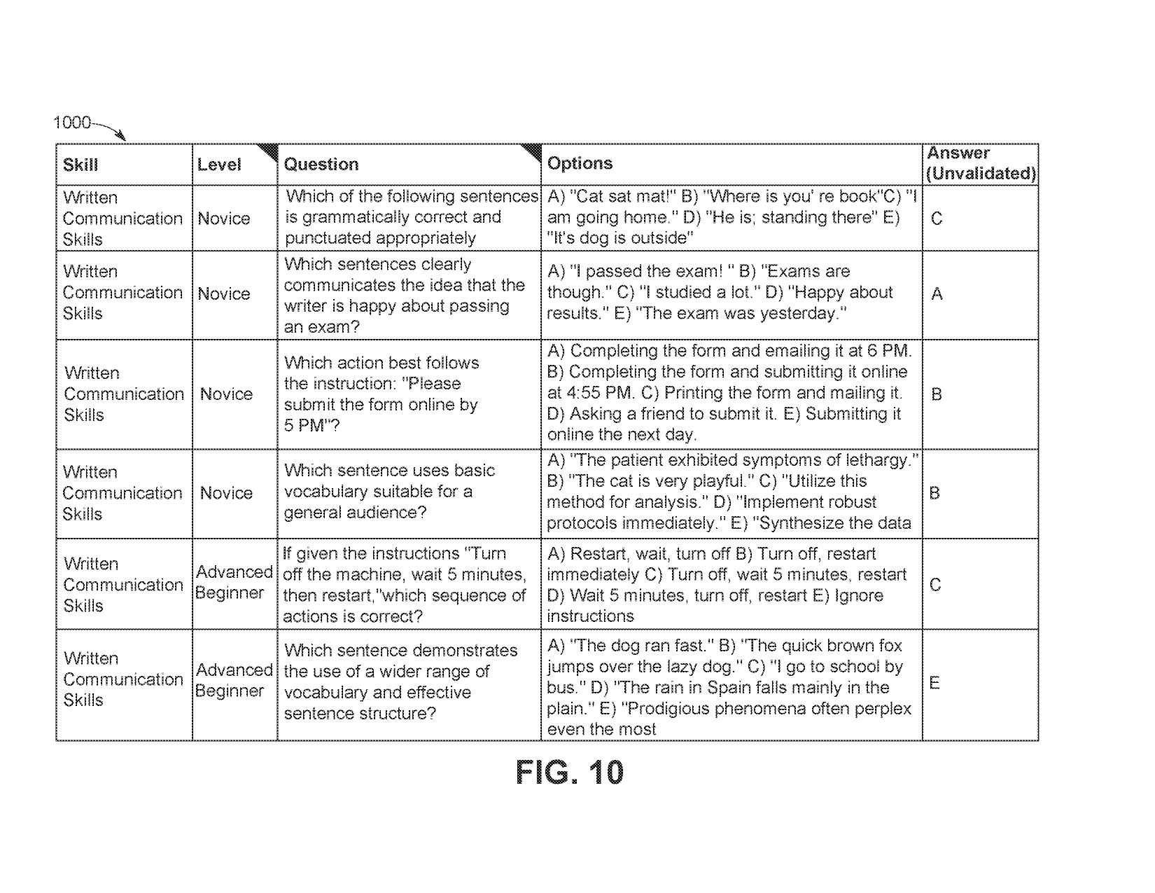

The skills proficiency assessments 324 can be designed in accordance with the skills proficiency framework 322 such that the answers provided by humans to the skills proficiency assessments 324 are indicative of the proficiency levels that are defined by the skills proficiency framework 322. The skills proficiency assessments 324 can thus provide an individual, instant, and unbiased self-assessment of skill proficiency. The functionality provided by the skills proficiency assessments 324 can allow managers to accurately measure the proficiency of their team and generate efficient plans for career development, for example. Referring to FIG. 10, an example table 1000 showing example questions that can be part of the skills proficiency assessments 324 is shown, in accordance with some aspects of the disclosure. Specifically, the questions shown in the table 1000 are multiple choice questions associated with “communication skills” and different levels of proficiency (e.g., novice, advanced beginner). The skills proficiency assessments 324 can be used to refresh career development plans with self-assessments, compare self-assessments to proficiency requirements for current and future occupations, and recognize expertise in specific skill areas.

The application programming interfaces 370 can provide access to data associated with the skills proficiency assessments 324 in various ways. For example, the application programming interfaces 370 can provide access to the skills proficiency assessments 324 and/or the associated skill proficiency evaluations for use by various organizations. The skill proficiency evaluations cam be provided as aggregated proficiency data associated with one or more humans, for example. The application programming interfaces 370 can also provide access to a verification service whereby humans can create credentials on a credentials network (e.g., in accordance with a policy as determined by a particular organization) based on results of the skills proficiency assessments 324. The application programming interfaces 370 can further provide access to customized analytics and reporting functionality for organizations to assess a workforce based on the skills proficiency assessments 324. The application programming interfaces 370 can also provide access to a training module that can be used to train different individuals on use of the skills proficiency assessments 324. The application programming interfaces 370 can further provide access to customized development features that allow organization to develop custom assessments (e.g., multiple choice tests, etc.) for specific combinations of the skills 316, the tasks 314, and/or the occupations 312 that align with the particular needs of an organization.

The workforce management system 300 is also shown to include an organization assessment system 330. The organization assessment system 330 generally provides functionality to measure the effects of the skills 316 on organizational performance. As such, the organization assessment system 330 can provide insight into how various aspects of workforce management can be optimized to improve operational efficiencies across various organizations (e.g., businesses and/or other types of organizations). Specifically, the organization assessment system 330 can be designed to establish connections between the tasks 314 across the occupations 312 by directly linking the tasks 314 to the associated skills 316 to be provide an organizational performance view of the skills 316. The organization assessment system 330 is shown to include both a task-skills framework 332 as well as a task-based process model 334.

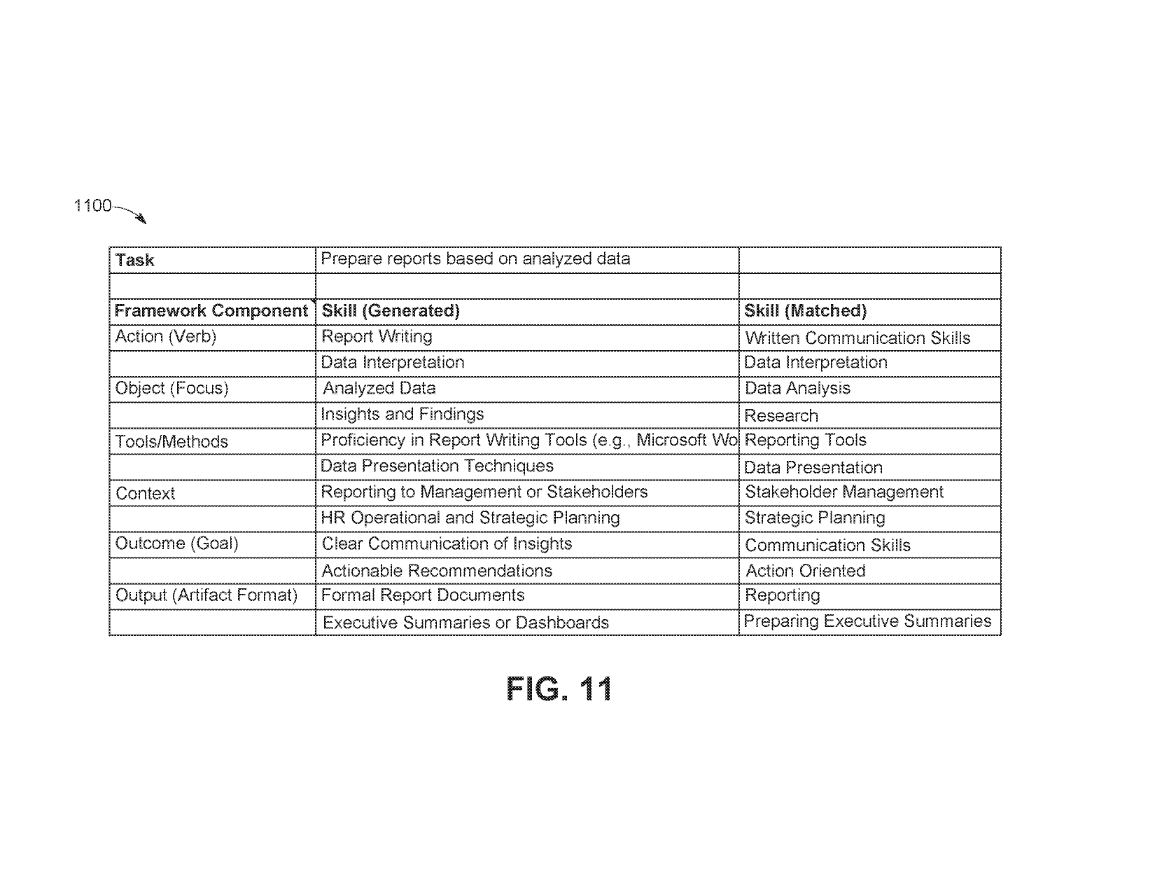

The task-skills framework 332 can generally provide a strategic integration of skill development with organizational performance, thereby marking a significant advancement in terms of how organizations can approach workforce training and competency management. The task-skills framework 332 specifically can algin workforce training initiatives directly with the tasks 314 and particular outcomes. By identifying and mapping the skills 316 to particular tasks 314, the task-skills framework 332 can provide organizations with a clear and actionable roadmap for employee workforce development. As such, the task-skills framework 332 can be used to align training with specific job requirements in a more dynamic and efficient manner than otherwise possible. Referring to FIG. 11, an example table 1100 showing example associations that can be part of the task-skills framework 332 is shown, in accordance with some aspects of the disclosure. Specifically, the associations shown in the table 1100 are associated with one of the tasks 314 called “prepare reports based on analyzed data” and include associations between components of the task-skills framework 332 and the skills 316. The task-skills framework 332 can be used to improve process performance with skill proficiencies for underlying tasks.

The application programming interfaces 370 can provide access to data and functionality associated with the task-skills framework 332 in various ways. For example, the application programming interfaces 370 can provide access to data associated with the task-skills framework 332, such as task-based data (e.g., per-task data linking the tasks 314 to the skills 316), skill-based data (e.g., per-skill data linking the skills 316 to the tasks 314), and/or occupation-based data (e.g., per-occupation data linking the occupations 312 to the tasks 314 and the skills 316). The application programming interfaces 370 can further provide access to customized analytics and reporting functionality for organizations to assess a workforce based on the task-skills framework 332. The application programming interfaces 370 can also provide access to a training module that can be used to train different individuals on use of the task-skills framework 332.

The task-based process model 334 generally forges a link between the skills 316 and organizational performance by mapping the skills 316 across key organizational functions. As a result, the task-based process model 334 can provide organizations with crucial insights into emerging skill development needs. The task-based process model 334 can provide an added layer to the ontology system 310 where the skills 316 are classified at the broad occupation level (e.g., through the tasks 314 and the occupations 312) by also mapping the skills 316 to various types of organizational processes. This alignment of the skills 316 with organizational processes can enable organizations to identify and anticipate emerging skills requirements and thereby provide organizations with a strategic edge in terms of workforce planning and optimization. The task-based process model 334 can additionally and/or alternatively align the skills 316 with the organizational processes by means of the tasks 314 in some examples. The linking of the skills 316, the tasks 314, and the organizational processes via the task-based process model 334 can be carefully crafted by experts and/or other sources (e.g., generative artificial intelligence, etc.).

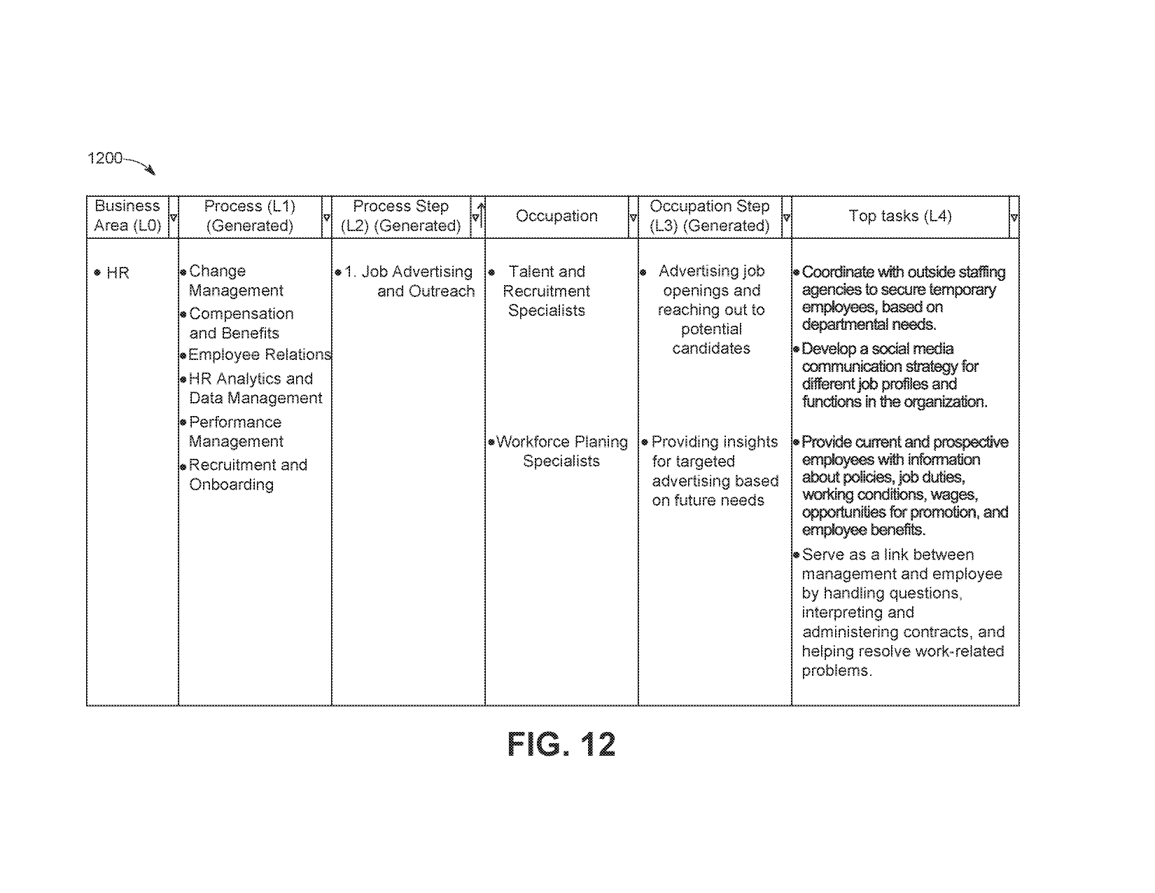

Referring to FIG. 12, an example table 1200 showing example associations that can be part of the task-based process model 334 is shown, in accordance with some aspects of the disclosure. Specifically, the associations shown in the table 1200 are associated with a human resources (HR) area of an organization. The associations shown in the table 1200 include different organizational processes (e.g., change management, recruiting and onboarding, job advertising and outreach, etc.) along with the associated occupations 312 (e.g., talent and recruitment specialist, workforce planning specialist) and the associated tasks 314 (e.g., coordinate with staffing agencies, develop social media strategy, etc.). The task-based process model 334 can provide organizations with the ability to review task similarity across a workforce and to see workforce capacity through a top-down process library.

The application programming interfaces 370 can provide access to data and functionality associated with the task-based process model 334 in various ways. For example, the application programming interfaces 370 can provide access to the task-based process model 334 by means of the linking of the occupations 312 to organizational processes through the tasks 314 and/or the skills 316. The application programming interfaces 370 can also provide access to analysis of how the tasks 314 across the occupations 312 relate to organizational outcomes and performance that can be generated based on the task-based process model 334. The application programming interfaces 370 can further provide access to customized analytics and reporting functionality for organizations to measure the impact of the skills 316 on organizational performance based on workforce data. The application programming interfaces 370 can also provide access to a training module that can be used to train different individuals on use of the task-based process model 334.

The workforce management system 300 is also shown to include a technology assessment system 340. The technology assessment system 340 generally provides functionality to measure the relevance and adoption of technologies (e.g., emerging technologies such as, e.g., generative artificial intelligence, large language models (LLMs), etc.) to the tasks 314. As such, the technology assessment system 340 can provide both tech-first and task-first analysis. The technology assessment system 340 is shown to include a tech taxonomy 342. The tech taxonomy 342 can be used to measure the impact of various technologies on a workforce by measuring the effects of technologies on the tasks 314 maintained by the ontology system 310. Additionally, the tech taxonomy 342 can be used to measure effects of technologies on the skills 316 and/or the occupations 312 maintained by the ontology system 310. The tech taxonomy 342 can categorize technologies into categories, groups, and types, for example, and then link the tasks 314 to types of technologies.

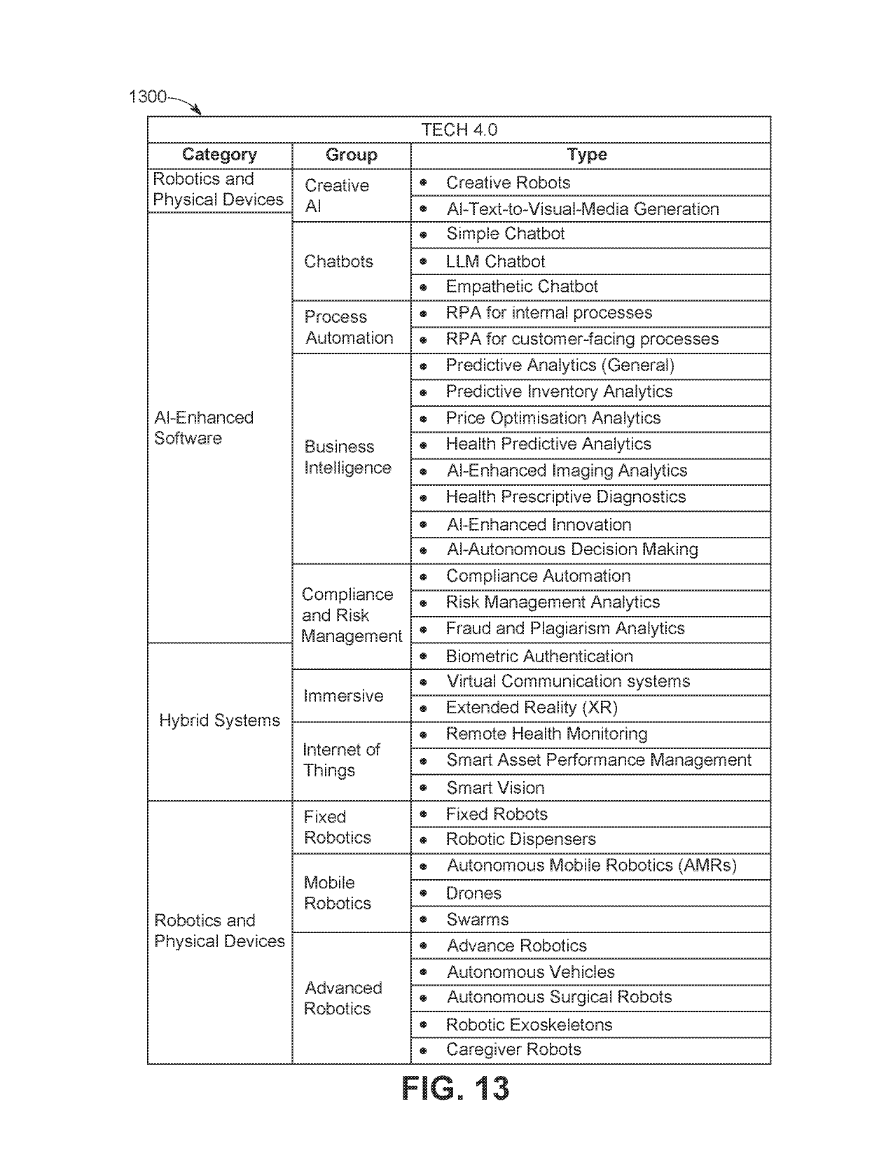

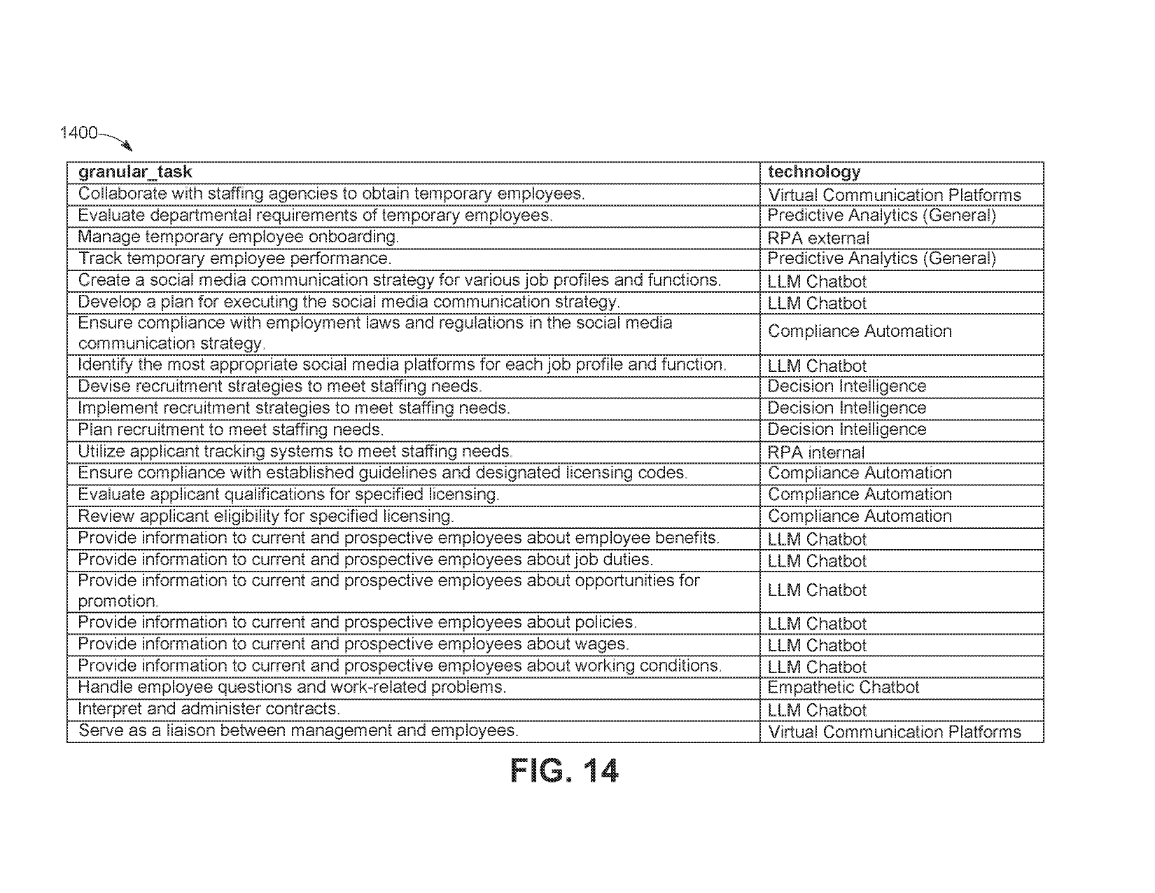

Referring to FIG. 13, an example table 1300 showing example associations that can be part of the tech taxonomy 342 is shown, in accordance with some aspects of the disclosure. Specifically, the associations shown in the table 1300 include categorization of technologies into broad categories, narrower groups, and even still narrower types. Referring to FIG. 14, an example table 1400 showing additional example associations that can be part of the tech taxonomy 342 is shown, in accordance with some aspects of the disclosure. Specifically, the associations shown in the table 1400 include associations between particular technology types (e.g., the types shown in the table 1300) and the tasks 314. The tech taxonomy 342 can also, in some examples, provide associations between the occupations 312 and/or the skills 316 and various technology types. The associations provided by the tech taxonomy 342 can be carefully crafted by experts and/or other sources (e.g., generative artificial intelligence, etc.). The associations that are provided by the tech taxonomy 342 can enable organizations to estimate the impact of various technologies on their workforce. For example, the tech taxonomy 342 can be used to facilitate strategic decision making for organizations regarding workforce training and investment in different technologies.

The application programming interfaces 370 can provide access to data and functionality that are associated with the tech taxonomy 342 in various ways. For example, the application programming interfaces 370 can provide per-user or per-task access to the tech taxonomy 342. The application programming interfaces 370 can also provide access to customized analytics and reporting functionality enabled by the tech taxonomy 342 for organizations to measure the impact of technologies on their workforce. The application programming interfaces 370 can also provide access to a training module that can be used to train different individuals on use of the tech taxonomy 342.

The workforce management system 300 is also shown to include an artificial intelligence assessment system 350. The artificial intelligence assessment system 350 generally provides functionality to assess artificial intelligence models and their performance capabilities with respect to the occupations 312, the tasks 314, and the skills 316. For example, the artificial intelligence assessment system 350 can maintain and/or generate assessment datasets for providing as input to various artificial intelligence models, and then the artificial intelligence assessment system 350 can assess the performance capabilities of the artificial intelligence models with respect to the occupations 312, the tasks 314, and the skills 316 based on outputs provided by the artificial intelligence models responsive to being prompted with the assessment datasets.

The artificial intelligence assessment system 350 is shown to include a skill proficiency arena 352. The skill proficiency arena 352 can generally provide one or more user interfaces to humans that have achieved a threshold level (e.g., an expert level) of proficiency with respect to one or more of the skills 316. Via the user interfaces provided by the skill proficiency arena 352, the humans that have achieved a threshold level of proficiency with respect to one or more of the skills 316 can submit one or more prompts for inclusion in one or more of the assessment datasets for providing as input to various artificial intelligence models. For example, experts can submit multiple choice questions via the skill proficiency arena 352 that are aimed at identifying and addressing potential weaknesses of leading artificial intelligence models. As a result, the skill proficiency arena 352 can facilitate the enhancement of the capabilities of artificial intelligence models (e.g., in educational and professional applications) by testing the limits of artificial intelligence models and actively involving human expertise in the process of artificial intelligence model development. The skill proficiency arena 352 can provide insight as to which of the occupations 312, the tasks 314, and the skills 316 are better performed by humans as opposed to artificial intelligence.

The application programming interfaces 370 can provide access to data and functionality associated with the skill proficiency arena 352 in various ways. For example, the application programming interfaces 370 can provide access to challenge data collected via the skill proficiency arena 352, including prompts created by experts and the associated responses provided by artificial intelligence models. The application programming interfaces 370 can further provide access to analysis regarding particular areas where human expertise surpasses the performance capabilities of artificial intelligence models (e.g., with respect to the occupations 312, the tasks 314, and/or the skills 316). The application programming interfaces 370 can also provide an interface to submit a custom artificial intelligence model for prompting using one or more assessments datasets associated with the skill proficiency arena 352 to assess weaknesses of the custom artificial intelligence model.

The artificial intelligence assessment system 350 is also shown to include an artificial intelligence assessment center 354. The artificial intelligence assessment center 354 can include any assessment datasets and associated results received from artificial intelligence models responsive to providing assessment datasets as input. Each of the assessment datasets maintained by the artificial intelligence assessment center 354 can include one or more prompts that are designed to assess the performance capabilities of artificial intelligence models with respect to one or more of the skills 316. Then, based on one or more outputs provided by the artificial intelligence models responsive to receiving the assessment datasets as input, the artificial intelligence assessment center 354 can generate and store benchmarking datasets indicative of the performance capabilities of the artificial intelligence models with respect to one or more of the skills 316. For example, the artificial intelligence assessment center 354 can leverage the skills proficiency framework 322 to assign proficiency levels to artificial intelligence models for various skills 316.

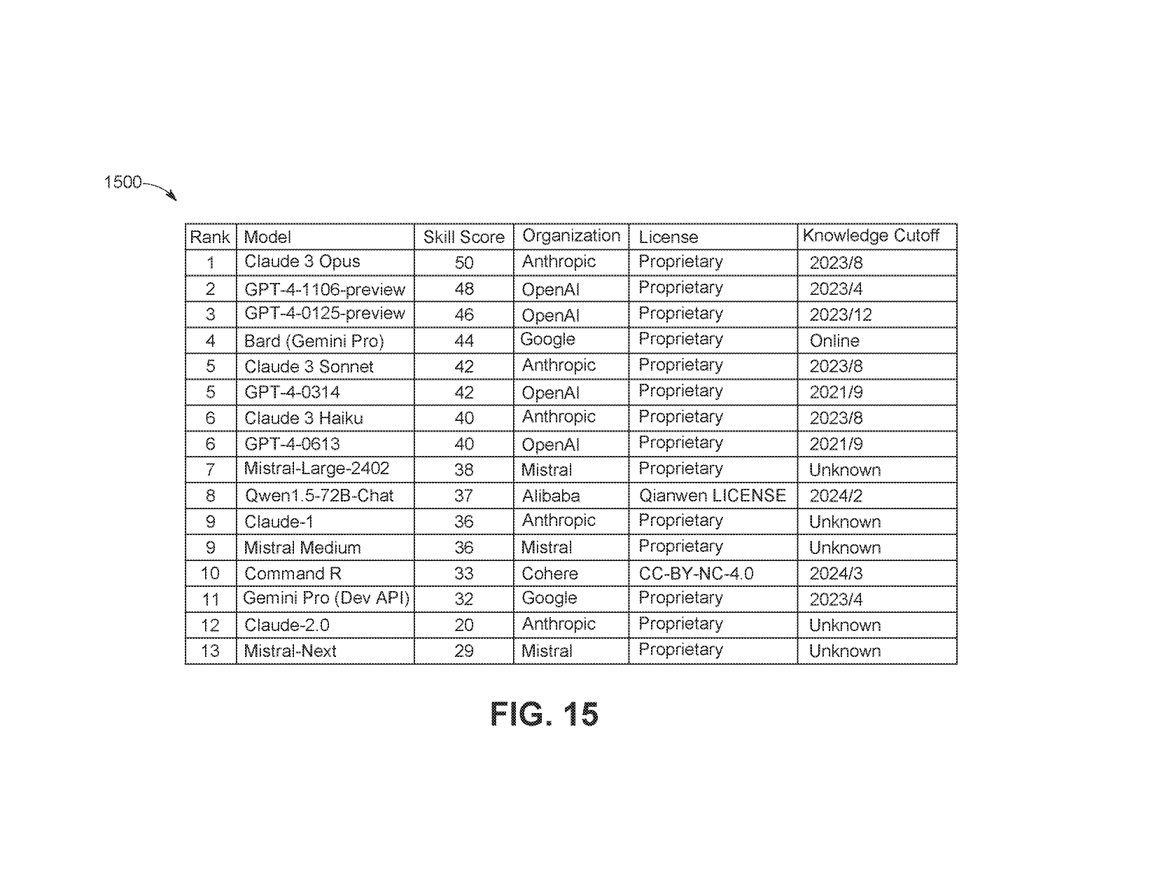

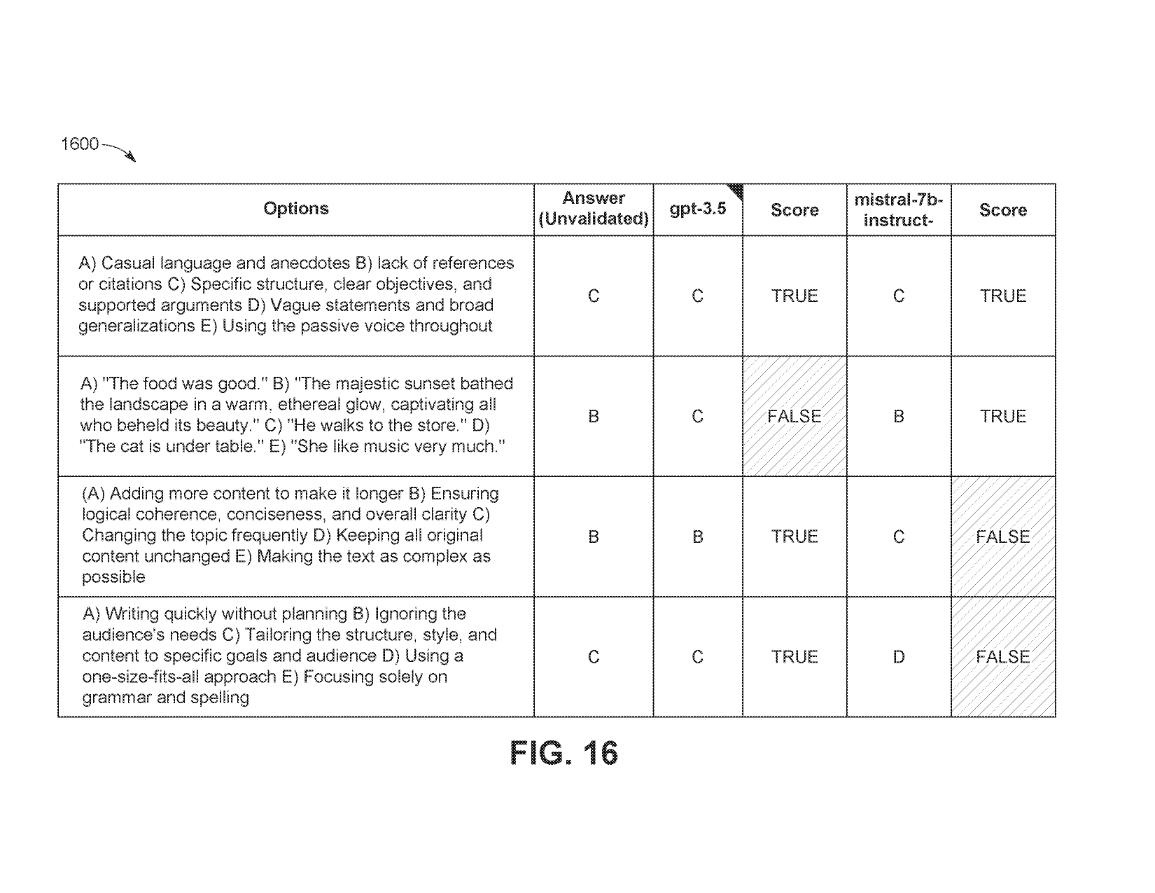

Referring to FIG. 15, an example table 1500 showing example data associated with different artificial intelligence models that can be maintained by the artificial intelligence assessment center 354 is shown, in accordance with some aspects of the disclosure. Specifically, the table 1500 ranks different artificial intelligence models based on a skill score for a particular one of the skills 316. The skill score can be generated based on the outputs received from the various artificial intelligence models responsive to providing assessment datasets as input. The table 1500 also includes organizations associated with the artificial intelligence models, license information associated with the artificial intelligence models, and knowledge cutoff dates associated with the artificial intelligence models. Referring to FIG. 16, another example table 1600 showing example data associated with different artificial intelligence models that can be maintained by the artificial intelligence assessment center 354 is shown, in accordance with some aspects of the disclosure. Specifically, the table 1600 includes various multiple choice questions that can be included in an assessment dataset, as well as answers provided by different artificial intelligence models to the multiple choice questions and associated scores.

The artificial intelligence assessment center 354 can provide a systematic review of various artificial intelligence models across the workforce skills 316, tasks 314, and/or occupations 312. The artificial intelligence assessment center 354 can also incorporate data related to cost of using various artificial intelligence models to identify the lowest cost model that is suited to performing a given one of the tasks 314 (e.g., based on the task-skills framework 332). Further, the artificial intelligence assessment center 354 can generate, store, and provide benchmarking datasets associated with various artificial intelligence models to ensure readiness of the artificial intelligence models for real-world deployment on actual work tasks. Accordingly, the artificial intelligence assessment center 354 can be used to understand the distribution of overall skills for various artificial intelligence models, find the lowest cost artificial intelligence model that is suited for a given task or skill, evaluate a new artificial intelligence model across a broad spectrum of skills, and various other functions.

The application programming interfaces 370 can provide access to data and functionality associated with the artificial intelligence assessment center 354 in various ways. For example, the application programming interfaces 370 can provide access (e.g., per-model access, etc.) to evaluation data pertaining to artificial intelligence model proficiency across the skills 316 (e.g., benchmarking datasets). The application programming interfaces 370 can also provide access (e.g., per-task access, etc.) to data for identifying the lowest cost artificial intelligence model suited to a given task (e.g., based on the task-skills framework 332). The application programming interfaces 370 can further provide the ability to submit a custom artificial intelligence model for assessing the custom artificial intelligence model based on one or more assessment datasets. The application programming interfaces 370 can further provide access to customized analytics and reporting functionality for organizations to assess proficiency of various artificial intelligence models with respect to their workforce data. The application programming interfaces 370 can further provide access to a training module that can be used to train different individuals on use of the artificial intelligence assessment center 354.

The workforce management system 300 is also shown to include a services system 360. The services system 360 generally provides functionality that leverages the ontology system 310, the human assessment system 320, the organization assessment system 330, the technology assessment system 340, and/or the artificial intelligence assessment system 350 to provide any of a number of workforce management services. Specifically, the services system 360 is shown to include custom model services 362, frontier content services 364, artificial intelligence director services 366, and learning content services 368. While these services are described in detail below, the services system 360 can provide additional services beyond these illustrated and described services and/or some of these illustrated and described services can be combined in various ways.

The custom model services 362 can generally involve generation and/or training of bespoke artificial intelligence models that are specifically generated and/or trained for particular purposes to optimize cost (financial and/or compute) and/or performance. For example, the custom model services 362 can generate and/or train a new custom artificial intelligence model to perform one or more of the tasks 314. The custom model services 362 can leverage the ontology system 310, the human assessment system 320, the organization assessment system 330, the technology assessment system 340, and/or the artificial intelligence assessment system 350 to generate and/or train specialized artificial intelligence solutions for different organizations and purposes. The creation and/or training of the custom artificial intelligence models by the custom model services 362 can be automated.

The custom artificial intelligence models created by the custom model services 362 can be tailored in accordance with proficiency needs for real-world processes in connection with the task-skills framework 332 and/or the task-based process model 334. The custom model services 362 can allow organizations to optimize artificial intelligence spend to precisely meet their operational needs. The custom model services 362 can generate various training datasets used to train custom artificial intelligence models using one or more prompts from the assessment datasets and corresponding outputs, for example. The custom artificial intelligence models can be large language models or any other suitable type of artificial intelligence models.

The application programming interfaces 370 can provide access to data and functionality associated with the custom model services 362 in various ways. For example, the application programming interfaces 370 can provide access to custom artificial intelligence model training services (e.g., per-job) by allowing selection of desired proficiencies (e.g., in terms of the tasks 314 and/or the skills 316) of the artificial intelligence model. The application programming interfaces 370 can further generate chat completions on a custom artificial intelligence model. The application programming interfaces 370 can also provide access to a training module that can be used to train different individuals on use of the custom model services 362.

The frontier content services 364 can generally involve facilitation of content creation pertaining specifically to content that cannot easily be replicated by artificial intelligence. For example, using the benchmarking datasets generated by the artificial intelligence assessment center 354 and/or insights that are provided through the skill proficiency arena 352, the workforce management system 300 can identify current skill limitations of artificial intelligence. Then, based on the current skill limitations of artificial intelligence, the frontier content services 364 can provide recommendations indicating that humans should produce certain types of frontier content in areas where artificial intelligence is deficient.

As a result, the frontier content services 364 can focus the development of human expertise in specific areas that are not easily replicated by artificial intelligence. Moreover, the frontier content that is created by humans based on the recommendations provided by the frontier content services 364 can be used to create training data to help remedy the identified deficiencies of artificial intelligence. Additionally, the frontier content that is created by humans based on the recommendations provided by the frontier content services 364 can be used to create learning materials to push human-level proficiency beyond that of artificial intelligence in particular areas. The application programming interfaces 370 can provide access to data and functionality associated with the custom model services 362 in various ways. For example, the application programming interfaces 370 can provide access to data indicative of educational content that is resistant to artificial intelligence. Specifically, the data can focus on areas of content creation that are not easily replicated by artificial intelligence.

The artificial intelligence director services 366 can generally provide delegation of tasks to appropriate artificial intelligence models to optimize cost and/or performance. For example, a user can submit a request to perform one of the tasks 314 via a user interface, and the workforce management system 300 can pass the request to perform the task to the artificial intelligence director services 366. The artificial intelligence director services 366 can then perform an evaluation of the request to perform the task relative to the benchmarking datasets maintained by the artificial intelligence assessment center 354 and/or the generate skill proficiency evaluations maintained by the human assessment system 320 to appropriately delegate the task to one or more artificial intelligence models and/or to one or more humans in a workforce.

The artificial intelligence director services 366 can process the request to perform the task by extracting one or more of the skills 316 associated with the task, and then evaluating the performance capabilities (e.g., proficiency levels) of one or more artificial intelligence models and/or to one or more humans in a workforce with respect to the one or more extracted skills. The application programming interfaces 370 can provide access to data and functionality associated with the artificial intelligence director services 366 in various ways. For example, the application programming interfaces 370 can provide functionality that allows organizations to submit requests to perform tasks and receive back a recommendation of how to complete the task.

The learning content services 368 can generally involve recommendations for learning (educational) content pertaining specifically to one or more of the skills 316 that cannot easily be replicated by artificial intelligence. Accordingly, the learning content services 368 can provide recommendations for “future-proof” or “future-important” skills that humans can develop and not overlap with the performance capabilities of artificial intelligence. The learning content services 368 can also leverage the benchmarking datasets generated by the artificial intelligence assessment center 354 and/or insights that are provided through the skill proficiency arena 352 to identify current skill limitations of artificial intelligence. Then, based on the current skill limitations of artificial intelligence, the learning content services 368 can provide recommendations that aid learners in focusing on skill development in areas least impacted by developments in artificial intelligence in workforce applications.

The learning content services 368 can provide personalized guidance to learners to help them identify and develop skills that remain crucial and relevant despite the rapid growth of artificial intelligence technologies. The learning content services 368 can generate and apply future proof scores to the skills 316 maintained by the ontology system 310 to help guide learning and to quantitatively measure the resilience of skills to artificial intelligence The application programming interfaces 370 can provide access to data and functionality associated with the learning content services 368 in various ways. For example, the application programming interfaces 370 can provide access to skills importance data (e.g., per-skill, etc.) such as, for example, future proof scores for the skills 316. The application programming interfaces 370 can also provide access to a training module that can be used to train different individuals on use of the learning content services 368.

The workforce management system 300 and its associated components as illustrated in FIG. 3 can be implemented using a variety of different hardware, software, firmware, and/or networking configurations, such as, for example, configuration that are similar to those detailed above with respect to the distributed computing environment 100 and the computing system 200. Moreover, the workforce management system 300 can include more, fewer, and/or alternative arrangements of the components as illustrated in FIG. 3. For example, the ontology system 310, the human assessment system 320, the organization assessment system 330, the technology assessment system 340, the artificial intelligence assessment system 350, and/or the services system 360 can be provided as the same component or as separate components depending on the specific implementation of the workforce management system 300.

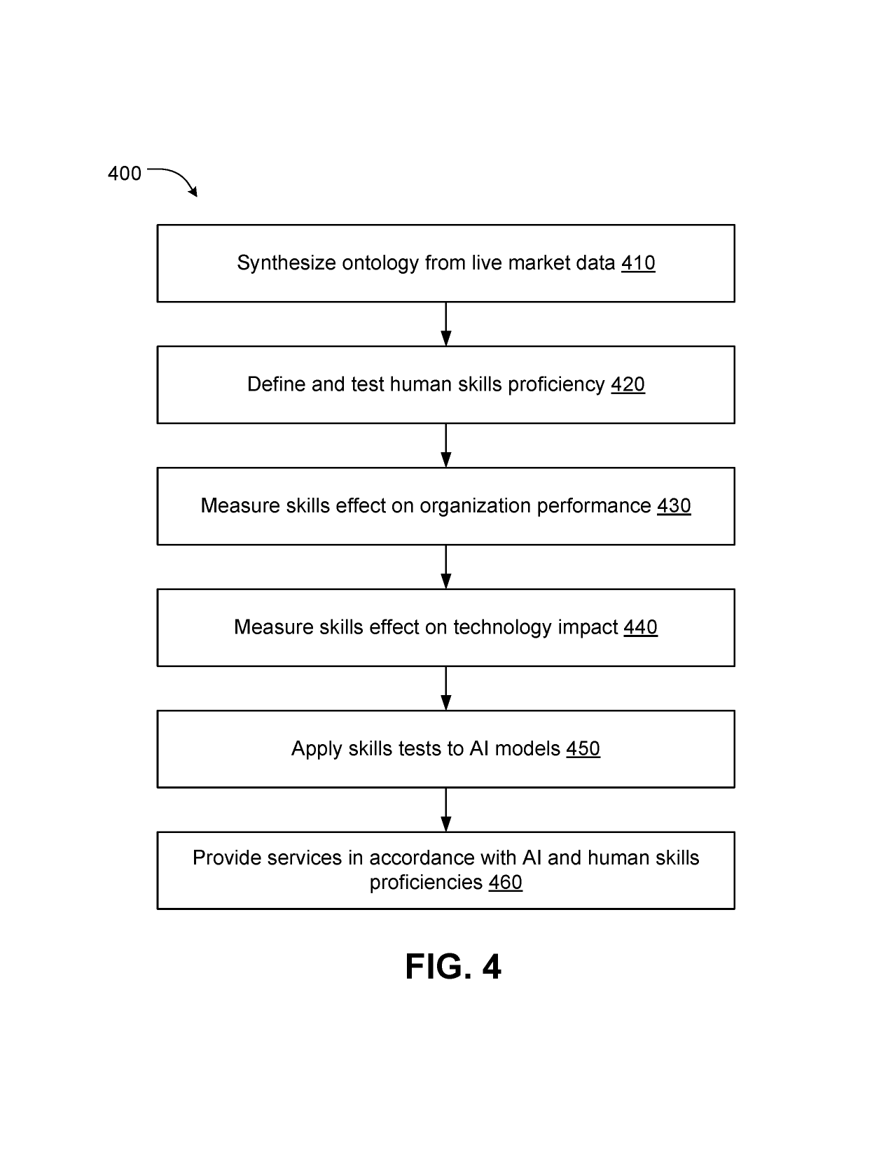

Referring to FIG. 4, a flowchart of an example process 400 for workforce management is shown, in accordance with some aspects of the disclosure. The process 400 can be performed by the workforce management system 300 as detailed above, for example. In general, the process 400 encompasses a variety of functionality that can be performed by the workforce management system 300 pertaining to balancing human and machine learning capabilities and accelerating productivity in a variety of applications. As an overview, the process 400 can be used to synthesize a structured ontology that can be leveraged to measure the proficiency of both humans and artificial intelligence and assess the impacts of technology and organizational processes. In some examples, one or more of the processes 500, 600, 700, and 800 as detailed below can be performed by the workforce management system 300 within the broader context of the process 400.

At 410, the process 400 can include synthesizing an ontology from live market data. For example, a computing system (e.g., one or more of the servers 102, the computing system 200, etc.) implementing at least a portion of the workforce management system 300 (e.g., the ontology system 310, etc.) can synthesize the ontology from live market data. The ontology that is synthesized at 410 can be the ontology of the occupations 312, the tasks 314, and the skills 316 that is maintained by the ontology system 310 as discussed above, for example. The ontology can be synthesized from various types of live market data such as, for example, the recent job postings available on the Internet and/or job and hiring market data from a variety of other available sources. Also, human input (e.g., expert otologist input, recruiter input, etc.) and/or artificial intelligence input (e.g., generative AI input, etc.) can be used to synthesize the ontology including the occupations 312, the tasks 314, and the skills 316. The ontology can be maintained and updated periodically as needed. Also, the process 400 can include applying the filter 318 to indicate skills mix and proficiency requirements that drive high performance within tasks and occupations.

At 420, the process 400 can include defining and testing human skills proficiency. For example, a computing system (e.g., one or more of the servers 102, the computing system 200, etc.) implementing at least a portion of the workforce management system 300 (e.g., the human assessment system 320, etc.) can define and test human skills proficiency. The process 400 can include both developing the skills proficiency framework 322 and providing the skills proficiency assessments 324 to generate skill proficiency evaluations for humans in a workforce. The process 400 can include developing the skills proficiency framework 322 to highlight individual learning needs across proficiency levels and to identify organizational skill gaps at a proficiency level. The skills proficiency framework 322 can allow the human assessment system 320 to enable comparison of the skills 316 across the occupations 312 side by side to help humans understand which of the skills 316 are important to development goals, for example. The process 400 can also include providing the skills proficiency assessments 324 to accurately gauge the skill level of humans in various domains associated with the skills 316. The skills proficiency assessments 324 can also be used to encourage learning and development of skills by providing users with credentials that demonstrate performance capabilities in various domains associated with the skills 316.

At 430, the process 400 can include linking skills to tasks and measuring the effects of skills on organizational performance. For example, a computing system (e.g., one or more of the servers 102, the computing system 200, etc.) implementing at least a portion of the workforce management system 300 (e.g., the organization assessment system 330, etc.) can link skills to tasks and measure the effects of skills on organizational performance. The process 400 can include developing the task-skills framework 332 and developing the task-based process model 334. The process 400 can include developing the task-skills framework 332 to provide a strategic integration of workforce skill development with organizational performance, thereby transforming how organizations can approach workforce training and competency management. The task-skills framework 332 can provide a mapping between the skills 316 and the tasks 314 of the ontology synthesized at 410 to help align training with specific job requirements in a more dynamic and efficient manner than otherwise possible. The process 400 can also include developing the task-based process model 334 to forge a link between the skills 316 and organizational performance by mapping the skills 316 across key organizational functions. The alignment of the skills 316 with organizational processes provided by the task-based process model 334 can enable organizations to identify and anticipate emerging skills requirements, and thereby provide organizations with a strategic edge in terms of workforce planning and optimization.

At 440, the process 400 can include measuring the effects of emerging technologies on skills and the associated tasks and occupations. For example, a computing system (e.g., one or more of the servers 102, the computing system 200, etc.) implementing at least a portion of the workforce management system 300 (e.g., the technology assessment system 340, etc.) can measure the effects of emerging technologies on skills and the associated tasks and occupations. The process 400 at 440 can include developing the tech taxonomy 342, for example. The process 400 can include developing the tech taxonomy 342 to measure the impact of various technologies on a workforce by measuring the effects of technologies on the tasks 314. The tech taxonomy 342 can then be used to measure the impact of various technologies on a workforce by can categorize technologies into categories, groups, and types, for example, and then link the tasks 314 to types of technologies.

At 450, the process 400 can include applying skills tests to artificial intelligence models. For example, a computing system (e.g., one or more of the servers 102, the computing system 200, etc.) implementing at least a portion of the workforce management system 300 (e.g., the artificial intelligence assessment system 350, etc.) can apply skills tests to artificial intelligence models. The skills tests applied at 450 can be the assessment datasets as discussed above that include a series of prompts associated with a set of the skills 316. The series of prompts can include at least one prompt submitted by a human that is associated with a proficiency level for at least one skill in the set of skills that exceeds a threshold proficiency level (e.g., at least one prompt provided via the skill proficiency arena 352). The assessment datasets can be configured for different testing purposes to test the performance capabilities of various artificial intelligence models. Based on the outputs that are provided by artificial intelligence models with responsive to receiving the assessment datasets as input, the process 400 can include assembling one or more benchmarking datasets indicative of the performance capabilities of the artificial intelligence models with respect to one or more of the skills 316.

At 460, the process 400 can include providing one or more services in accordance with the skills proficiencies of different humans and artificial intelligence models. For example, a computing system (e.g., one or more of the servers 102, the computing system 200, etc.) implementing at least a portion of the workforce management system 300 (e.g., the services system 360, etc.) can provide one or more services in accordance with the skills proficiencies of different humans and artificial intelligence models. The process 400 can leverage the skill proficiency evaluations for humans in a workforce along with the benchmarking datasets indicative of the performance capabilities of the artificial intelligence models to provide the custom model services 362, the frontier content services 364, the artificial intelligence director services 366, and/or the learning content services 368. The process 400 can include providing the custom model services 362 to generate and/or train bespoke artificial intelligence models that are specifically generated and/or trained for particular purposes to optimize cost (financial and/or compute) and/or performance. The process 400 can include providing the frontier content services 364 to facilitate content creation pertaining specifically to content that cannot easily be replicated by artificial intelligence. The process 400 can include providing the artificial intelligence director services 366 provide delegation of tasks to appropriate artificial intelligence models and/or humans to optimize cost and/or performance. The process 400 can include providing the learning content services 368 to recommend learning (educational) content pertaining to skills that cannot easily be replicated by artificial intelligence capabilities.

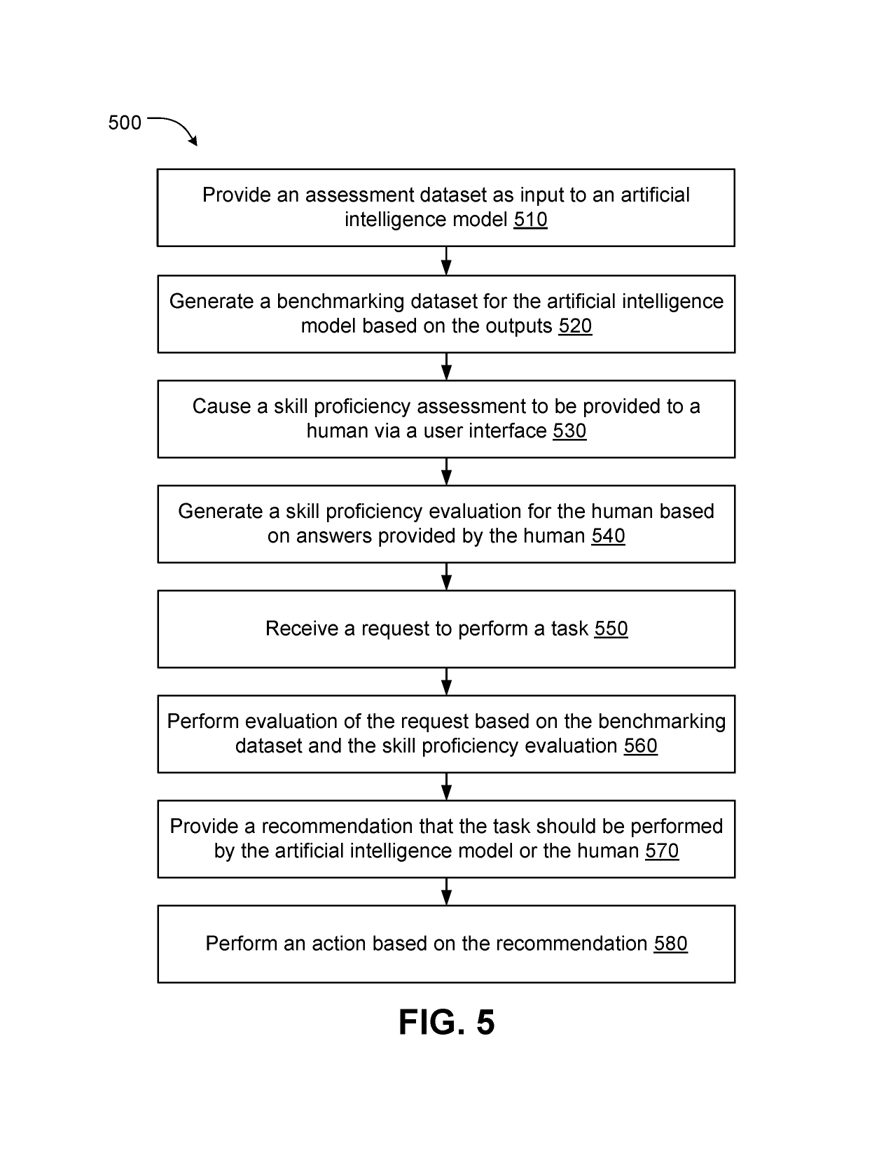

Referring to FIG. 5, a flowchart showing another example process 500 for workforce management is shown, in accordance with some aspects of the disclosure. The process 500 can be performed by the workforce management system 300 as detailed above, for example. The process 500 specifically pertains to delegation of tasks between artificial intelligence and humans. For example, the artificial intelligence director services 366 as detailed above can provide at least some of the functionality with respect to the process 500 by providing delegation services of tasks to appropriate artificial intelligence models or to humans to optimize cost and/or performance. As a result, the process 500 can be used to incorporate artificial intelligence models into organizational workflows in a careful manner that does not induce excess costs and/or dislocation of human components of a workforce.

At 510, the process 500 can include providing an assessment dataset as input to an artificial intelligence model. For example, a computing system (e.g., one or more of the servers 102, the computing system 200, etc.) implementing at least a portion of the workforce management system 300 (e.g., the artificial intelligence assessment system 350, etc.) can provide the assessment dataset as input to the artificial intelligence model (e.g., by transmitting the assessment dataset via one or more of the communication networks 120, etc.). The assessment dataset can include a series of prompts associated with a set of the skills 316. The series of prompts can include at least one prompt submitted by a human that is associated with a proficiency level for at least one skill in the set of skills that exceeds a threshold proficiency level (e.g., at least one prompt provided via the skill proficiency arena 352). The assessment dataset can be configured for different purposes to test the performance capabilities of the artificial intelligence model with respect to the particular set of the skills 316. The assessment dataset in some examples can be very large in size. For example, the assessment dataset can be on the order of 200,000 prompts. The process 500 can include providing the assessment dataset as input to the artificial intelligence model in any suitable manner such as, for example, directly, indirectly, through an application programming interface, or through a web interface. The artificial intelligence model can be any type of artificial intelligence model such as, for example, a large language model or another type of artificial intelligence model.

At 520, the process 500 can include generating a benchmarking dataset for the artificial intelligence model based on outputs generated by the artificial intelligence model responsive to receiving the assessment dataset as input. For example, a computing system (e.g., one or more of the servers 102, the computing system 200, etc.) implementing at least a portion of the workforce management system 300 (e.g., the artificial intelligence assessment system 350, etc.) can generate the benchmarking dataset for the artificial intelligence model based on outputs received from the artificial intelligence model (e.g., via one or more of the communication networks 120, etc.) responsive to receiving the assessment dataset as input. The process 500 can include generating the benchmarking dataset by evaluating the outputs that are generated by the artificial intelligence model responsive to receiving the assessment dataset as input relative to the skills proficiency framework 322, for example. The benchmarking dataset generally can be indicative of the performance capabilities of the artificial intelligence model with respect to the set of the skills 316 associated with the assessment dataset. For example, the benchmarking dataset can provide numerical scores for different skills in the set of the skills 316, the benchmarking dataset can provide Boolean indicators (e.g., true/false, competent/incompetent, etc.) for different skills in the set of the skills 316, and/or the benchmarking dataset can provide any other suitable mechanism for indicating the performance capabilities of the artificial intelligence model with respect to the set of the skills 316 associated with the assessment dataset. In some examples, the benchmarking dataset can indicate a proficiency level for the artificial intelligence model in accordance with the skills proficiency framework 322 (e.g., ranging from novice to expert) for different skills in the set of the skills 316 associated with the assessment dataset.

At 530, the process 500 can include causing a skill proficiency assessment to be provided to a human via a user interface. For example, a computing system (e.g., one or more of the servers 102, the computing system 200, etc.) implementing at least a portion of the workforce management system 300 (e.g., the human assessment system 320, etc.) can cause (e.g., by sending data to one of the client devices 106 via one or more of the communication networks 120, etc.) the skill proficiency assessment to be provided to a human via a user interface. The process 500 can include causing one of the skills proficiency assessments 324 to be provided to a human in a workforce via a user interface on a user device. The user interface can be any suitable type of user interface (e.g., web interface, application interface, etc.) and the user device can be any suitable type of user device (e.g., smartphone, laptop, etc.). The skill proficiency assessment can be provided in accordance with the skills proficiency framework 322. The skill proficiency assessment can include multiple choice tests and/or other types of tests designed to measure the proficiency of the human with respect to the set of the skills 316 associated with the assessment dataset.

At 540, the process 500 can include generating a skill proficiency evaluation for the human based on answers provided by the human to the skill proficiency assessment. For example, a computing system (e.g., one or more of the servers 102, the computing system 200, etc.) implementing at least a portion of the workforce management system 300 (e.g., the human assessment system 320, etc.) can generate the skill proficiency evaluation for the human based on answers provided by the human to the skill proficiency assessment (e.g., based on data received from one of the client devices 106 via one or more of the communication networks 120, etc.). The process 500 an include generating the skill proficiency evaluation for the human by evaluating the answers provided by the human to the skill proficiency assessment relative to the skills proficiency framework 322, for example. The answers can be provided by the human to the skill proficiency assessment via the user device in any suitable manner (e.g., through touch screen inputs, through keyboard and/or mouse inputs, through voice inputs, etc.). The skill proficiency evaluation can be indicative of the performance capabilities of the human with respect to the set of the skills 316 associated with the assessment dataset. The skill proficiency evaluation can provide numerical scores for different skills in the set of the skills 316, the skill proficiency evaluation can provide Boolean indicators for different skills in the set of the skills 316, and/or the benchmarking dataset can provide any other suitable mechanism for indicating the performance capabilities of the human with respect to the set of the skills 316 associated with the assessment dataset. In some examples, the skill proficiency evaluation can indicate a proficiency level for the human in accordance with the skills proficiency framework 322 (e.g., ranging from novice to expert) for different skills in the set of the skills 316 associated with the assessment dataset.

At 550, the process 500 can include receiving a request to perform a task. For example, a computing system (e.g., one or more of the servers 102, the computing system 200, etc.) implementing at least a portion of the workforce management system 300 (e.g., the services system 360, etc.) can receive the request to perform the task (e.g., via one or more of the communication networks 120, etc.). The task can be one of the tasks 314 maintained and defined in the ontology system 310, for example. The request to perform the task can be received in any suitable manner and from any suitable source. For example, a human associated with workforce management (e.g., a manager at a company, a human resources employee at a company, etc.) can submit the request to perform the task via any suitable user interface associated with the workforce management system 300. The request to perform the task can also be submitted automatically (e.g., by agentic artificial intelligence, etc.) by any of a variety of suitable computing systems associated with an organization. The task can be related to, for example, report writing, data interpretation, data presentation, strategic planning, document summarizing, or a variety of other possible types of tasks.

At 560, the process 500 can include performing an evaluation of the request to perform the task based on the benchmarking dataset for the artificial intelligence model and the skill proficiency evaluation for the human. For example, a computing system (e.g., one or more of the servers 102, the computing system 200, etc.) implementing at least a portion of the workforce management system 300 (e.g., the services system 360, etc.) can perform the evaluation of the request to perform the task based on the benchmarking dataset for the artificial intelligence model and the skill proficiency evaluation for the human. The process 500 can include extracting one or more of the skills 316 that are associated with the requested task 314 from the ontology system 310. Then, the process 500 can include comparing the extracted skills 316 to the associated performance capabilities (e.g., proficiency levels, etc.) indicated by the benchmarking dataset and the skill proficiency evaluation, respectively. The process 500 can further include performing the evaluation based on this comparison in a variety of suitable manners, such as, for example, by averaging performance capabilities across the extracted skills 316, weighting the extracted skills 316 based on relevance to the requested task, based on cost of using the artificial intelligence model to perform the task, based on availability and/or time commitment required by the human to complete the task, and/or a variety of other factors. The evaluation performed at 560 can be done using agentic artificial intelligence without human prompting. For example, the workforce management system 300 can grant or enable one or more artificial intelligence models that are implemented in the workforce management system 300 or that are interacted with by the workforce management system 300 (e.g., via the application programming interfaces 370, etc.) to act in an autonomous fashion such that the evaluation performed at 560 can be done dynamically by agentic artificial intelligence.

At 570, the process 500 can include providing a recommendation indicating that the task should be performed by the artificial intelligence model or that the task should be performed by the human based on the evaluation. For example, a computing system (e.g., one or more of the servers 102, the computing system 200, etc.) implementing at least a portion of the workforce management system 300 (e.g., the services system 360, etc.) can provide the recommendation (e.g., via one or more of the communication networks 120, etc.) indicating that the task should be performed by the artificial intelligence model or that the task should be performed by the human based on the evaluation. The recommendation can be provided in any suitable manner, such as to the human via the user interface on the user device, via an e-mail message, via a text message, via a push notification, and/or via a phone call and/or voicemail. The recommendation can then be used as appropriate by the receiving party to allocate the task as appropriate to the human or to the artificial intelligence model. In some examples, the process 500 can include providing the recommendation to an automated software system (e.g., any of the components of the workforce management system 300 and/or an external system associated with a particular organization) such that the recommendation does not necessarily need to be provided to a human. For example, the recommendation provided at 570 can also be done using agentic artificial intelligence without human prompting. The workforce management system 300 can grant or enable one or more artificial intelligence models that are implemented in the workforce management system 300 or that are interacted with by the workforce management system 300 (e.g., via the application programming interfaces 370, etc.) to act in an autonomous fashion such that the recommendation can be provided dynamically at 570 by agentic artificial intelligence.

At 580, the process 500 can include performing an action based on the recommendation. For example, a computing system (e.g., one or more of the servers 102, the computing system 200, etc.) implementing at least a portion of the workforce management system 300 (e.g., the services system 360, etc.) can perform the action based on the recommendation. When the recommendation indicates that the task should be performed by the artificial intelligence model, the process 500 can include performing the task using the artificial intelligence model. As another example, when the recommendation indicates that the task should be performed by the human, the process 500 can include causing a user interface to be provided to the appropriate human (e.g., by transmitting data over one or more of the communication networks 120 to one of the client device 106, etc.) that facilitates performance of the task by the human. The action performed at 580 can also include, for example, any of a variety of other suitable actions such as, for example, providing supporting documents and/or other materials to the appropriate human(s), storing a historical record of the recommendation and/or the evaluation, generating training data based on the recommendation and/or the evaluation, providing a response to the request to perform the task, and/or any other suitable type of action. In this manner, the workforce management system 300 can provide various user interfaces for personnel (e.g., in human resources) that can facilitate organizational efficiencies in terms of adopting and utilizing artificial intelligence to enhance operations and workforce productivity.

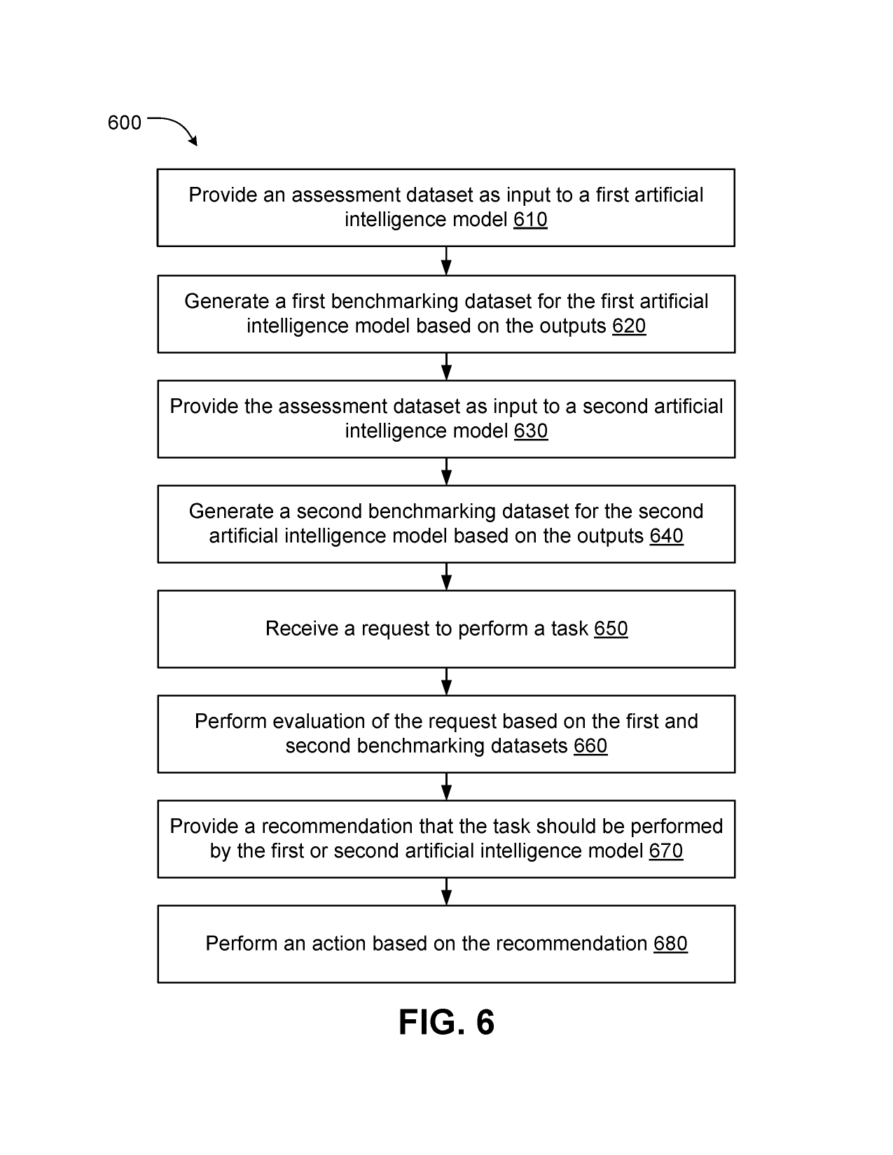

Referring to FIG. 6, a flowchart showing yet another example process 600 for workforce management is shown, in accordance with some aspects of the disclosure. The process 600 can be performed by the workforce management system 300 as detailed above, for example. The process 600 can be performed by the workforce management system 300 as detailed above, for example. The process 600 specifically pertains to delegation of tasks to artificial intelligence models based on factors such as performance capabilities and costs associated with different artificial intelligence models. For example, the artificial intelligence director services 366 as detailed above can provide at least some of the functionality with respect to the process 600 by providing delegation services of tasks to artificial intelligence models based on various parameters associated with the artificial intelligence models.

At 610, the process 600 can include providing an assessment dataset as input to a first artificial intelligence model. For example, a computing system (e.g., one or more of the servers 102, the computing system 200, etc.) implementing at least a portion of the workforce management system 300 (e.g., the artificial intelligence assessment system 350, etc.) can provide the assessment dataset as input to the first artificial intelligence model (e.g., by transmitting the assessment dataset via one or more of the communication networks 120, etc.). The assessment dataset can include a series of prompts associated with a set of the skills 316. The series of prompts can include at least one prompt submitted by a human that is associated with a proficiency level for at least one skill in the set of skills that exceeds a threshold proficiency level (e.g., at least one prompt provided via the skill proficiency arena 352). The assessment dataset can be configured for different purposes to test the performance capabilities of the first artificial intelligence model with respect to the particular set of the skills 316. The assessment dataset in some examples can be very large in size. For example, the assessment dataset can be on the order of 200,000 prompts. The process 600 can include providing the assessment dataset as input to the artificial intelligence model in any suitable manner such as, for example, directly, indirectly, through an application programming interface, or through a web interface. The first artificial intelligence model can be any type of artificial intelligence model such as, for example, a large language model or another type of artificial intelligence model.

At 620, the process 600 can include generating a first benchmarking dataset for the first artificial intelligence model based on outputs generated by the first artificial intelligence model responsive to receiving the assessment dataset as input. For example, a computing system (e.g., one or more of the servers 102, the computing system 200, etc.) implementing at least a portion of the workforce management system 300 (e.g., the artificial intelligence assessment system 350, etc.) can generate the first benchmarking dataset for the first artificial intelligence model based on outputs received from the first artificial intelligence model (e.g., via one or more of the communication networks 120, etc.) responsive to receiving the assessment dataset as input. The process 600 can include generating the first benchmarking dataset by evaluating the outputs that are generated by the first artificial intelligence model responsive to receiving the assessment dataset as input relative to the skills proficiency framework 322, for example.

The first benchmarking dataset generally can be indicative of the performance capabilities of the first artificial intelligence model with respect to the set of the skills 316 associated with the assessment dataset. For example, the first benchmarking dataset can provide numerical scores for different skills in the set of the skills 316, the first benchmarking dataset can provide Boolean indicators for different skills in the set of the skills 316, and/or the first benchmarking dataset can provide any other suitable mechanism for indicating the performance capabilities of the first artificial intelligence model with respect to the set of the skills 316 associated with the assessment dataset. The first benchmarking dataset can indicate a proficiency level for the first artificial intelligence model in accordance with the skills proficiency framework 322 (e.g., ranging from novice to expert) for different skills in the set of the skills 316 associated with the assessment dataset.

At 630, the process 600 can include providing the assessment dataset as input to a second artificial intelligence model. For example, a computing system (e.g., one or more of the servers 102, the computing system 200, etc.) implementing at least a portion of the workforce management system 300 (e.g., the artificial intelligence assessment system 350, etc.) can provide the assessment dataset as input to the second artificial intelligence model (e.g., by transmitting the assessment dataset via one or more of the communication networks 120, etc.). The assessment dataset provided as input to the second artificial intelligence model can be the same assessment dataset as provided to the first artificial intelligence model or can be overlapping with the assessment dataset provided to the first artificial intelligence model (e.g., can include many of the same prompts). The process 600 can again include providing the assessment dataset as input to the second artificial intelligence model in any suitable manner such as, for example, directly, indirectly, through an application programming interface, or through a web interface, among other possible approaches. The second artificial intelligence model can also be any type of artificial intelligence model such as, for example, a large language model or another type of artificial intelligence model.

At 640, the process 600 can include generating a second benchmarking dataset for the second artificial intelligence model based on outputs generated by the second artificial intelligence model responsive to receiving the assessment dataset as input. For example, a computing system (e.g., one or more of the servers 102, the computing system 200, etc.) implementing at least a portion of the workforce management system 300 (e.g., the artificial intelligence assessment system 350, etc.) can generate the second benchmarking dataset for the second artificial intelligence model based on outputs received from the second artificial intelligence model (e.g., via one or more of the communication networks 120, etc.) responsive to receiving the assessment dataset as input. The process 600 can include generating the second benchmarking dataset by evaluating the outputs that are generated by the second artificial intelligence model responsive to receiving the assessment dataset as input relative to the skills proficiency framework 322, for example.

The second benchmarking dataset generally can be indicative of the performance capabilities of the second artificial intelligence model with respect to the set of the skills 316 associated with the assessment dataset. For example, the second benchmarking dataset can provide numerical scores for different skills in the set of the skills 316, the second benchmarking dataset can provide Boolean indicators for different skills in the set of the skills 316, and/or the second benchmarking dataset can provide any other suitable mechanism for indicating the performance capabilities of the second artificial intelligence model with respect to the set of the skills 316 associated with the assessment dataset. The second benchmarking dataset can indicate a proficiency level for the second artificial intelligence model in accordance with the skills proficiency framework 322 (e.g., ranging from novice to expert) for different skills in the set of the skills 316 associated with the assessment dataset.

At 650, the process 600 can include receiving a request to perform a task. For example, a computing system (e.g., one or more of the servers 102, the computing system 200, etc.) implementing at least a portion of the workforce management system 300 (e.g., the services system 360, etc.) can receive the request to perform the task (e.g., via one or more of the communication networks 120, etc.). The requested task can be one of the tasks 314 maintained and defined in the ontology system 310, for example. The request to perform the task can be received in any suitable manner and from any suitable source. For example, a human associated with workforce management (e.g., a manager at a company, a human resources employee at a company, etc.) can submit the request to perform the task via any suitable user interface associated with the workforce management system 300. The request to perform the task can also be submitted automatically (e.g., by agentic artificial intelligence, etc.) by any of a variety of suitable computing systems associated with an organization. The task can be related to, for example, report writing, data interpretation, data presentation, strategic planning, document summarizing, or a variety of other possible types of tasks.

At 660, the process 600 can include performing an evaluation of the request to perform the task based on the first benchmarking dataset for the first artificial intelligence model and based on the second benchmarking dataset for the second artificial intelligence model. For example, a computing system (e.g., one or more of the servers 102, the computing system 200, etc.) implementing at least a portion of the workforce management system 300 (e.g., the services system 360, etc.) can perform the evaluation of the request to perform the task based on the first benchmarking dataset for the first artificial intelligence model and the second benchmarking dataset for the second artificial intelligence model. The process 600 can include extracting one or more of the skills 316 that are associated with the requested task 314 from the ontology system 310. Then, the process 600 can include comparing the extracted skills 316 to the associated performance capabilities (e.g., proficiency levels, etc.) indicated by the first benchmarking dataset and the second benchmarking dataset, respectively. The process 600 can include performing the evaluation based on this comparison in a variety of suitable manners, such as by averaging performance capabilities across the extracted skills 316, weighting the extracted skills 316 based on relevance to the requested task, based on cost of using the first and second artificial intelligence models to perform the task, and/or a variety of other factors.

At 670, the process 600 can include providing a recommendation indicating that the task should be performed by the first artificial intelligence model or that the task should be performed by the second artificial intelligence model based on the evaluation. For example, a computing system (e.g., one or more of the servers 102, the computing system 200, etc.) implementing at least a portion of the workforce management system 300 (e.g., the services system 360, etc.) can provide the recommendation (e.g., via one or more of the communication networks 120, etc.) indicating that the task should be performed by the first artificial intelligence model or that the task should be performed by the second artificial intelligence model based on the evaluation. The recommendation can be provided in any suitable manner, such as to a human via the user interface on the user device, via an e-mail message, via a text message, via a push notification, and/or via a phone call and/or voicemail. The recommendation can then be used as appropriate by the receiving party to allocate the task as appropriate to the first artificial intelligence model or the second artificial intelligence model. In some examples, the process 600 can include providing the recommendation to an automated software system (e.g., any of the components of the workforce management system 300 and/or an external system associated with a particular organization) such that the recommendation does not necessarily need to be provided to a human.

At 680, the process 600 can include performing an action based on the recommendation. For example, a computing system (e.g., one or more of the servers 102, the computing system 200, etc.) implementing at least a portion of the workforce management system 300 (e.g., the services system 360, etc.) can perform the action based on the recommendation. The process 600 can include performing the requested task using the first artificial intelligence model or the second artificial intelligence model in accordance with the recommendation, for example (e.g., providing the appropriate prompts and/or other data to the first artificial intelligence model or the second artificial intelligence model to cause the first artificial intelligence model or the second artificial intelligence model to generate one or more outputs associated with the requested task). The action performed at 680 can also include any of a variety of other suitable actions such as, for example, providing supporting documents and/or other materials to the appropriate human(s), storing a historical record of the recommendation and/or the evaluation, generating training data based on the recommendation and/or the evaluation, providing a response to the request to perform the task, and/or any other suitable type of action. In this manner, the workforce management system 300 can provide various user interfaces for personnel (e.g., in human resources) that can facilitate organizational efficiencies in terms of adopting and utilizing artificial intelligence to enhance operations and workforce productivity.

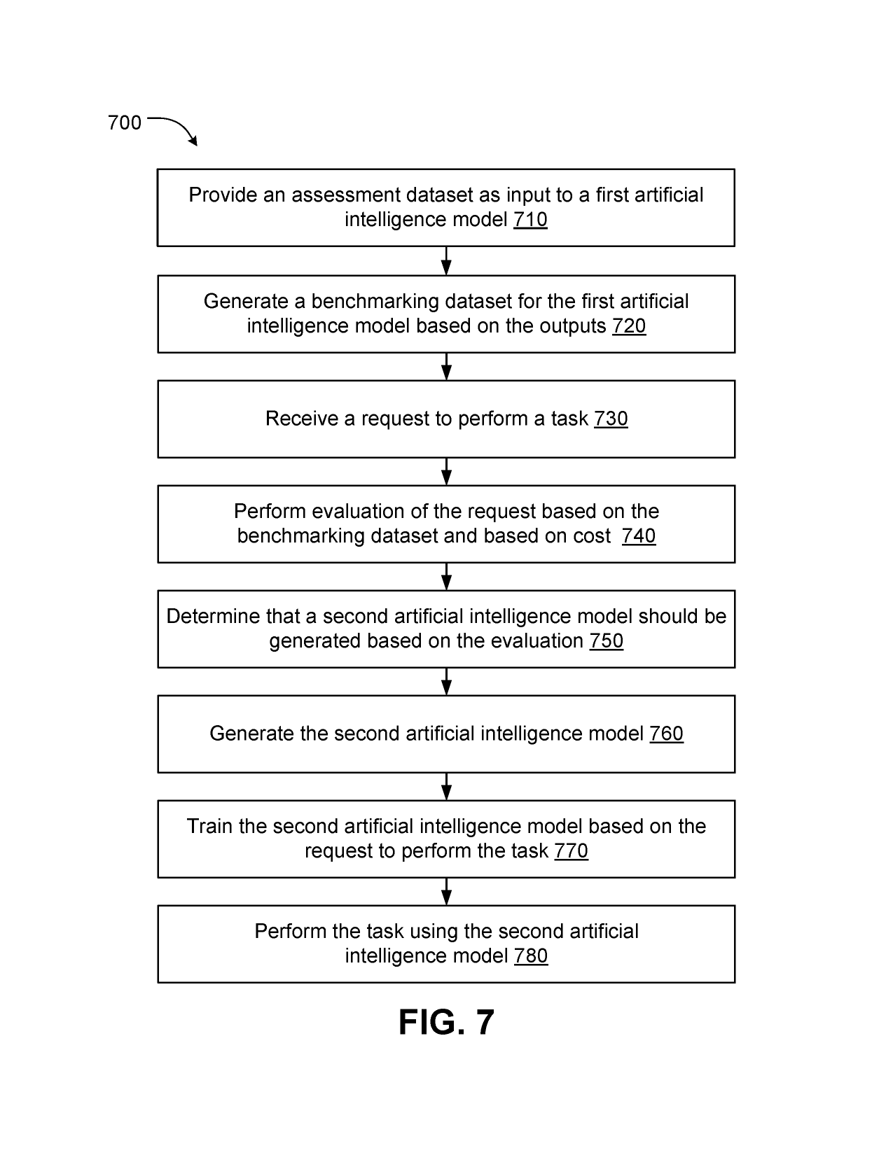

Referring to FIG. 7, a flowchart showing a further example process 700 for workforce management is shown, in accordance with some aspects of the disclosure. The process 700 can be performed by the workforce management system 300 as detailed above, for example. The process 700 pertains to generation of custom artificial intelligence models as appropriate for different organizations based on factors such as performance capabilities and costs associated with already available artificial intelligence models. For example, the custom model services 362 as detailed above can provide at least some of the functionality with respect to the process 700 by providing generation and/or training of bespoke artificial intelligence models that are specifically generated and/or trained for particular purposes.

At 710, the process 700 can include providing an assessment dataset as input to an artificial intelligence model. For example, a computing system (e.g., one or more of the servers 102, the computing system 200, etc.) implementing at least a portion of the workforce management system 300 (e.g., the artificial intelligence assessment system 350, etc.) can provide the assessment dataset as input to the artificial intelligence model (e.g., by transmitting the assessment dataset via one or more of the communication networks 120, etc.). The assessment dataset can include a series of prompts associated with a set of the skills 316. The series of prompts can include at least one prompt submitted by a human that is associated with a proficiency level for at least one skill in the set of skills that exceeds a threshold proficiency level (e.g., at least one prompt provided via the skill proficiency arena 352). The assessment dataset can be configured for different purposes to test the performance capabilities of the artificial intelligence model with respect to the particular set of the skills 316. The assessment dataset in some examples can be very large in size. For example, the assessment dataset can be on the order of 200,000 prompts. The process 700 can include providing the assessment dataset as input to the artificial intelligence model in any suitable manner such as, for example, directly, indirectly, through an application programming interface, or through a web interface. The artificial intelligence model can be any type of artificial intelligence model such as, for example, a large language model or another type of artificial intelligence model.

At 720, the process 700 can include generating a benchmarking dataset for the artificial intelligence model based on outputs generated by the artificial intelligence model responsive to receiving the assessment dataset as input. For example, a computing system (e.g., one or more of the servers 102, the computing system 200, etc.) implementing at least a portion of the workforce management system 300 (e.g., the artificial intelligence assessment system 350, etc.) can generate the benchmarking dataset for the artificial intelligence model based on outputs received from the artificial intelligence model (e.g., via one or more of the communication networks 120, etc.). The process 700 can include generating the benchmarking dataset by evaluating the outputs that are generated by the artificial intelligence model responsive to receiving the assessment dataset as input relative to the skills proficiency framework 322, for example. The benchmarking dataset generally can be indicative of the performance capabilities of the artificial intelligence model with respect to the set of the skills 316 associated with the assessment dataset. For example, the benchmarking dataset can provide numerical scores for different skills in the set of the skills 316, the benchmarking dataset can provide Boolean indicators for skills in the set of the skills 316, and/or the benchmarking dataset can provide any other suitable mechanism for indicating the performance capabilities of the artificial intelligence model with respect to the set of the skills 316 associated with the assessment dataset. In some examples, the benchmarking dataset can indicate a proficiency level for the artificial intelligence model in accordance with the skills proficiency framework 322 (e.g., ranging from novice to expert) for different skills in the set of the skills 316 associated with the assessment dataset.

At 730, the process 700 can include receiving a request to perform a task. For example, a computing system (e.g., one or more of the servers 102, the computing system 200, etc.) implementing at least a portion of the workforce management system 300 (e.g., the services system 360, etc.) can receive the request to perform the task (e.g., via one or more of the communication networks 120, etc.). The requested task can be one of the tasks 314 maintained and defined in the ontology system 310, for example. The request to perform the task can be received in any suitable manner and from any suitable source. For example, a human associated with workforce management (e.g., a manager at a company, a human resources employee at a company, etc.) can submit the request to perform the task via any suitable user interface associated with the workforce management system 300. The request to perform the task can also be submitted automatically (e.g., by agentic artificial intelligence, etc.) by any of a variety of suitable computing systems associated with an organization. The task can be related to, for example, report writing, data interpretation, data presentation, strategic planning, document summarizing, or a variety of other possible types of tasks.

At 740, the process 700 can include performing an evaluation of the request to perform the task based on the benchmarking dataset for the artificial intelligence model and based on a cost associated with the artificial intelligence model. For example, a computing system (e.g., one or more of the servers 102, the computing system 200, etc.) implementing at least a portion of the workforce management system 300 (e.g., the services system 360, etc.) can perform the evaluation of the request to perform the task based on the benchmarking dataset for the artificial intelligence model and based on the cost associated with the artificial intelligence model. The process 700 can include extracting one or more of the skills 316 that are associated with the requested task 314 from the ontology system 310. Then, the process 700 can include comparing the extracted skills 316 to the associated performance capabilities (e.g., proficiency levels, etc.) indicated by the benchmarking dataset. The process 700 can include performing the evaluation based on this comparison in a variety of suitable manners, such as by averaging performance capabilities across the extracted skills 316, weighting the extracted skills 316 based on relevance to the requested task, and/or a variety of other factors. The cost associated with the artificial intelligence model can be a variety of costs such as, for example, an actual or estimated cost to perform the task, a general cost per prompt token, or any other suitable cost metric.

At 750, the process 700 can include determining that a second artificial intelligence model should be generated based on the evaluation. For example, a computing system (e.g., one or more of the servers 102, the computing system 200, etc.) implementing at least a portion of the workforce management system 300 (e.g., the artificial intelligence assessment system 350, the services system 360, etc.) can determine that the second artificial intelligence model should be generated based on the evaluation. Responsive to determining that the artificial intelligence model associated with the benchmarking dataset is too costly to perform the requested task and/or that the artificial intelligence model associated with the benchmarking dataset is not proficient enough to perform the requested task with the desired level of accuracy, the process 700 can determine determining that a second artificial intelligence model should be generated. In some examples, a cost threshold and/or an accuracy threshold can be implemented in order to make this determination at 750. For example, the cost threshold can be configured based on organizational preferences (e.g., entered via a user input) and/or based on a known or estimated cost of creating the second artificial intelligence model. The accuracy threshold can be configured based on organizational preferences (e.g., entered via a user input) and/or based on a known or estimated accuracy level of the second artificial intelligence model. Additionally, the process 700 can include evaluating a broader set of artificial intelligence models including more than just the first artificial intelligence model relative to the requested task (e.g., based on associated benchmarking datasets) before determining that the second artificial intelligence model should be generated.

At 760, the process 700 can include generating the second artificial intelligence model responsive to determining that the second artificial intelligence model should be generated based on the evaluation. For example, a computing system (e.g., one or more of the servers 102, the computing system 200, etc.) implementing at least a portion of the workforce management system 300 (e.g., the services system 360, etc.) can itself generate and/or cause another computing system to generate the second artificial intelligence model responsive to determining that the second artificial intelligence model should be generated based on the evaluation (e.g., by transmitting data via one or more of the communication networks 120, etc.). The second artificial intelligence model can be any type of artificial intelligence model such as, for example, a large language model or another type of artificial intelligence model.

At 770, the process 700 can include training the second artificial intelligence model based on the request to perform the task. For example, a computing system (e.g., one or more of the servers 102, the computing system 200, etc.) implementing at least a portion of the workforce management system 300 (e.g., the services system 360, etc.) can itself train and/or cause another computing system to train the second artificial intelligence model based on the request to perform the task (e.g., by transmitting data via one or more of the communication networks 120, etc.). The process 700 can include selecting the second artificial intelligence model by assessing a set of available artificial intelligence models and determine which of the set of available artificial intelligence models is closest to being adequate for performing the requested task (e.g., based on associated benchmarking datasets). In some examples, the second artificial intelligence model can be the same base artificial intelligence model as the first artificial intelligence model but subject to focused training for the requested task. The process 700 can include generating a training dataset based on the at least one skill in the set of the skills 316 and applying the training dataset to the second artificial intelligence model. The training dataset can be generated by the custom model services 362, for example. The training dataset can include using one or more prompts from the assessment datasets and corresponding outputs, for example. In some implementations, a user can select desired proficiencies (e.g., in terms of the tasks 314 and/or the skills 316) of the second artificial intelligence model, and the process 700 can include generating the training dataset based on the desired proficiency selected by the user.

At 780, the process 700 can include performing the requested task using the trained second artificial intelligence model. For example, a computing system (e.g., one or more of the servers 102, the computing system 200, etc.) implementing at least a portion of the workforce management system 300 (e.g., the services system 360, etc.) can perform the requested task using the trained second artificial intelligence model (e.g., by transmitting data via one or more of the communication networks 120, etc.). Since the second artificial intelligence model has been trained specifically based on the request to perform the task, the requested task can generally be performed in a more efficient manner using the second artificial intelligence model than using the first artificial intelligence model. For example, the process 700 can include providing the appropriate prompts and/or other data to the second artificial intelligence model (e.g., via one or more of the communication networks 120, etc.) to cause the second artificial intelligence model to generate one or more outputs associated with the requested task. In this manner, the workforce management system 300 can provide various user interfaces for personnel (e.g., in human resources) that can facilitate organizational efficiencies in terms of adopting and utilizing artificial intelligence to enhance operations and workforce productivity.

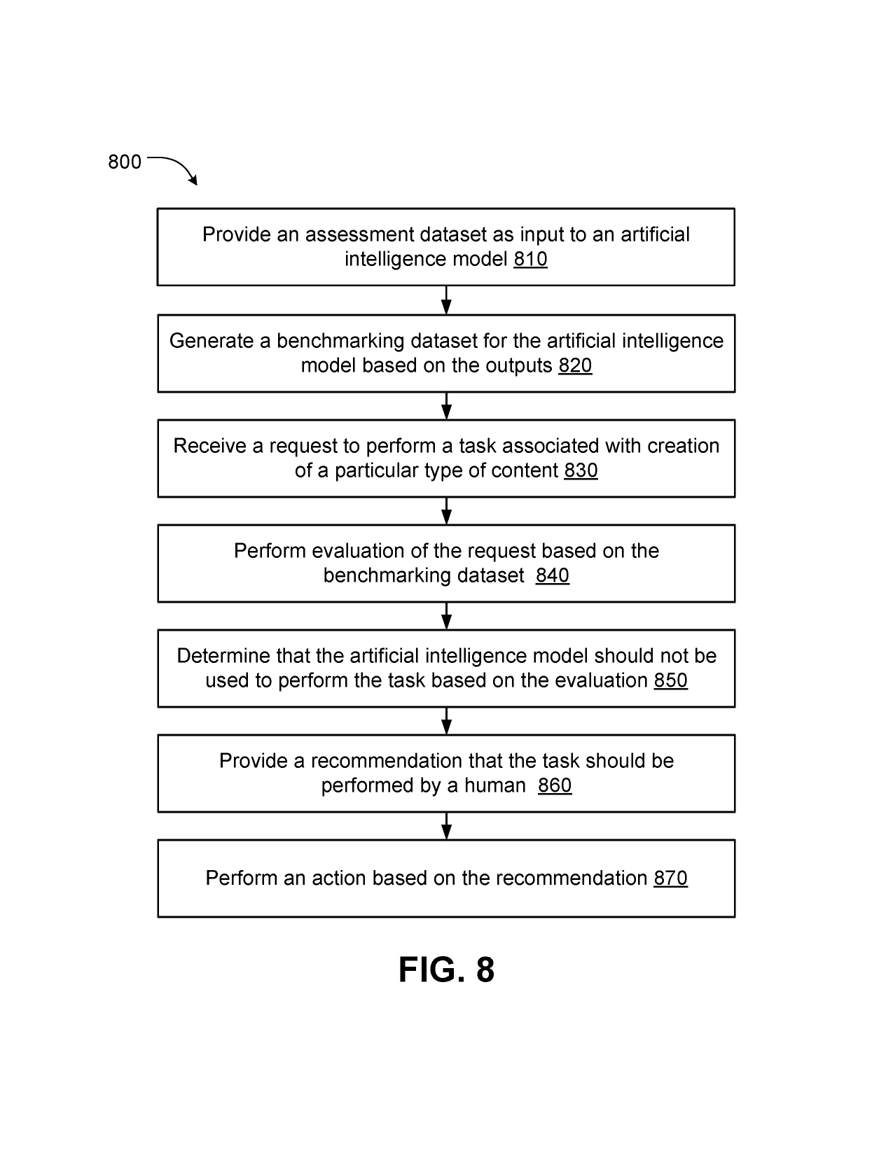

Referring to FIG. 8, a flowchart showing a still further example process 800 for workforce management is shown, in accordance with some aspects of the disclosure. The process 800 can be performed by the workforce management system 300 as detailed above, for example. The process 800 specifically pertains to frontier content and learning content recommendations that can be provided by the workforce management system 300 based on analysis of current artificial intelligence capabilities. For example, the frontier content services 364 and/or the learning content services 368 as detailed above can provide at least some of the functionality with respect to the process 800 by providing recommendations for creation of frontier content and provision of learning content based on analysis of current artificial intelligence capabilities.

At 810, the process 800 can include providing an assessment dataset as input to an artificial intelligence model. For example, a computing system (e.g., one or more of the servers 102, the computing system 200, etc.) implementing at least a portion of the workforce management system 300 (e.g., the artificial intelligence assessment system 350, etc.) can provide the assessment dataset as input to the artificial intelligence model (e.g., by transmitting the assessment dataset via one or more of the communication networks 120, etc.). The assessment dataset can include a series of prompts associated with a set of the skills 316. The series of prompts can include at least one prompt submitted by a human that is associated with a proficiency level for at least one skill in the set of skills that exceeds a threshold proficiency level (e.g., at least one prompt provided via the skill proficiency arena 352). The assessment dataset can be configured for different purposes to test the performance capabilities of the artificial intelligence model with respect to the particular set of the skills 316. The assessment dataset in some examples can be very large in size. For example, the assessment dataset can be on the order of 200,000 prompts. The process 800 can include providing the assessment dataset as input to the artificial intelligence model in any suitable manner such as, for example, directly, indirectly, through an application programming interface, or through a web interface. The artificial intelligence model can be any type of artificial intelligence model such as, for example, a large language model or another type of artificial intelligence model.

At 820, the process 800 can include generating a benchmarking dataset for the artificial intelligence model based on outputs generated by the artificial intelligence model responsive to receiving the assessment dataset as input. For example, a computing system (e.g., one or more of the servers 102, the computing system 200, etc.) implementing at least a portion of the workforce management system 300 (e.g., the artificial intelligence assessment system 350, etc.) can generate the benchmarking dataset for the artificial intelligence model based on outputs received from the artificial intelligence model (e.g., via one or more of the communication networks 120, etc.) responsive to receiving the assessment dataset as input. The process 800 can include generating the benchmarking dataset by evaluating the outputs that are generated by the artificial intelligence model responsive to receiving the assessment dataset as input relative to the skills proficiency framework 322, for example. The benchmarking dataset generally can be indicative of the performance capabilities of the artificial intelligence model with respect to the set of the skills 316 associated with the assessment dataset. For example, the benchmarking dataset can provide numerical scores for different skills in the set of the skills 316, the benchmarking dataset can provide Boolean indicators for skills in the set of the skills 316, and/or the benchmarking dataset can provide any other suitable mechanism for indicating the performance capabilities of the artificial intelligence model with respect to the set of the skills 316 associated with the assessment dataset. In some examples, the benchmarking dataset can indicate a proficiency level for the artificial intelligence model in accordance with the skills proficiency framework 322 (e.g., ranging from novice to expert) for different skills in the set of the skills 316 associated with the assessment dataset.

At 830, the process 800 can include receiving a request to perform a task that is associated with creation of a particular type of content. For example, a computing system (e.g., one or more of the servers 102, the computing system 200, etc.) implementing at least a portion of the workforce management system 300 (e.g., the services system 360, etc.) can receive the request to perform the task (e.g., via one or more of the communication networks 120, etc.). The task can be one of the tasks 314 maintained and defined in the ontology system 310, for example. The task can be associated with the creation of a particular type of educational content (e.g., homework assignments, text-based educational reading content in a specific field, etc.), for example. The request to perform the task can be received in any suitable manner and from any suitable source model (e.g., via one or more of the communication networks 120, etc.). For example, a human associated with workforce management (e.g., a manager at a company, a human resources employee at a company, etc.) can submit the request to perform the task via any suitable user interface associated with the workforce management system 300. The request to perform the task can also be submitted automatically (e.g., by agentic artificial intelligence, etc.) by any of a variety of suitable computing systems associated with an organization.

At 840, the process 800 can include performing an evaluation of the request to perform the task based on the benchmarking dataset for the artificial intelligence model and based on a cost associated with the artificial intelligence model. For example, a computing system (e.g., one or more of the servers 102, the computing system 200, etc.) implementing at least a portion of the workforce management system 300 (e.g., the services system 360, etc.) can perform the evaluation of the request to perform the task based on the benchmarking dataset for the artificial intelligence model and based on the cost associated with the artificial intelligence model. The process 800 can include extracting one or more of the skills 316 that are associated with the requested task 314 from the ontology system 310. Then, the process 800 can include comparing the extracted skills 316 to the associated performance capabilities (e.g., proficiency levels, etc.) indicated by the benchmarking dataset. The process 800 can include performing the evaluation based on this comparison in a variety of suitable manners, such as by averaging performance capabilities across the extracted skills 316, weighting the extracted skills 316 based on relevance to the requested task, a cost associated with performing the requested task using the artificial intelligence model, and/or a variety of other factors.

At 850, the process 800 can include determining that the artificial intelligence model should not be used to perform the task that is associated with creation of the content based on the evaluation. For example, a computing system (e.g., one or more of the servers 102, the computing system 200, etc.) implementing at least a portion of the workforce management system 300 (e.g., the artificial intelligence assessment system 350, the services system 360, etc.) can determine that the artificial intelligence model should not be used to perform the task that is associated with creation of the content based on the evaluation. For example, responsive to determining that the artificial intelligence model associated with the benchmarking dataset is too costly to perform the requested task and/or that the artificial intelligence model associated with the benchmarking dataset is not proficient enough to perform the requested task with the desired level of accuracy, the process 800 can determine determining that the artificial intelligence model should not be used to perform the task that is associated with creation of the content. In some examples, a cost threshold and/or an accuracy threshold can be implemented in order to make this determination at 850. For example, the cost threshold can be configured based on organizational preferences (e.g., entered via a user input) and/or based on a known or estimated cost of using the artificial intelligence model to perform the requested task. The accuracy threshold can be configured based on organizational preferences (e.g., entered via a user input) and/or based on a known or estimated accuracy level of the artificial intelligence model. Additionally, the process 800 can include evaluating multiple artificial intelligence models relative to the requested task (e.g., based on associated benchmarking datasets) and determine more generally that artificial intelligence should not be used to perform the requested task.

At 860, the process 800 can include providing a recommendation indicating that the task should be performed by a human based on the evaluation. For example, a computing system (e.g., one or more of the servers 102, the computing system 200, etc.) implementing at least a portion of the workforce management system 300 (e.g., the services system 360, etc.) can provide the recommendation (e.g., via one or more of the communication networks 120, etc.) indicating that the task should be performed by a human based on the evaluation. The recommendation can be provided in any suitable manner, such as to the human via the user interface on the user device, via an e-mail message, via a text message, via a push notification, and/or via a phone call and/or voicemail. The recommendation can then be used as appropriate by the receiving party to allocate the task as appropriate to the human. In some examples, the process 800 can include providing the recommendation to an automated software system (e.g., any of the components of the workforce management system 300 and/or and external system associated with a particular organization) such that the recommendation does not necessarily need to be provided to a human.

At 870, the process 800 can include performing an action based on the recommendation. For example, a computing system (e.g., one or more of the servers 102, the computing system 200, etc.) implementing at least a portion of the workforce management system 300 (e.g., the services system 360, etc.) can perform the action based on the recommendation. The action can include causing a user interface to be provided to the appropriate human (e.g., by transmitting data over one or more of the communication networks 120 to one of the client device 106, etc.) that facilitates performance of the task by the human, for example. The action can also include any of a variety of other suitable actions such as, for example, providing supporting documents and/or other materials to the appropriate human(s), storing a historical record of the recommendation and/or the evaluation, generating training data based on the recommendation and/or the evaluation, providing a response to the request to perform the task, and/or any other suitable type of action. Based on the recommendation, the human can create frontier content such as described above with the frontier content services 364, for example. The action performed at 870 can also include providing a learning content recommendation such as described above with the learning content services 368, for example. In this manner, the workforce management system 300 can provide various user interfaces for personnel (e.g., in human resources) that can facilitate organizational efficiencies in terms of adopting and utilizing artificial intelligence to enhance operations and workforce productivity.

It should be noted that, while the steps of the processes 400, 500, 600, 700, and 800 are shown in a particular order in FIGS. 5-8, in some implementations, the processes 400, 500, 600, 700, and 800 may not include all steps shown, may include additional steps, and/or may include the steps in a different order. Further, the steps of the processes 400, 500, 600, 700, and 800 can be combined in various manners in certain implementations.

Other examples and uses of the disclosed technology will be apparent to those having ordinary skill in the art upon consideration of the disclosure. The specification and examples given should be considered as examples only, and it is contemplated that the appended claims will cover any other such implementation or modifications as fall within the true scope of the invention.

1. A computer-implemented method, comprising:
providing an assessment dataset as input to an artificial intelligence model, the assessment dataset comprising a series of prompts associated with a set of skills;
generating a benchmarking dataset for the artificial intelligence model based on outputs generated by the artificial intelligence model responsive to receiving the assessment dataset as input, the benchmarking dataset indicative of performance capabilities of the artificial intelligence model with respect to the set of skills;
causing a skill proficiency assessment to be provided to a human via a user interface on a user device, the skill proficiency assessment comprising a series of questions associated with the set of skills;
generating a skill proficiency evaluation for the human based on answers provided by the human to the series of questions via the user interface on the user device, the skill proficiency assessment indicative of performance capabilities of the human with respect to the set of skills;
receiving a request to perform a task, the task associated with at least one skill in the set of skills;
performing an evaluation of the request to perform the task based on the benchmarking dataset for the artificial intelligence model and the skill proficiency evaluation for the human; and
providing a recommendation indicating that the task should be performed by the artificial intelligence model or that the task should be performed by the human based on the evaluation.

2. The method of claim 1, comprising performing the evaluation of the request to perform the task based on a cost associated with the artificial intelligence model.

3. The method of claim 1, comprising performing the task using the artificial intelligence model when the recommendation indicates that the task should be performed by the artificial intelligence model.

4. The method of claim 1, comprising prompting the human to perform the task via the user device when the recommendation indicates that the task should be performed by the human.

5. The method of claim 1, comprising performing the evaluation of the request to perform the task based on a time commitment required of the human to perform the task.

6. The method of claim 1, wherein the series of prompts comprises at least one prompt submitted by a second human, the second human being associated with a proficiency level for at least one skill in the set of skills that exceeds a threshold proficiency level.

7. The method of claim 1, wherein receiving the request to perform the task comprises receiving the request to perform the task based on an input provided by a human via a second user interface on a second user device.

8. A non-transitory computer-readable storage medium having instructions stored thereon that, when executed by processing circuitry, cause the processing circuitry to:
provide an assessment dataset as input to an artificial intelligence model, the assessment dataset comprising a series of prompts associated with a set of skills;
generate a benchmarking dataset for the artificial intelligence model based on outputs generated by the artificial intelligence model responsive to receiving the assessment dataset as input, the benchmarking dataset indicative of performance capabilities of the artificial intelligence model with respect to the set of skills;
cause a skill proficiency assessment to be provided to a human via a user interface on a user device, the skill proficiency assessment comprising a series of questions associated with the set of skills;
generate a skill proficiency evaluation for the human based on answers provided by the human to the series of questions via the user interface on the user device, the skill proficiency assessment indicative of performance capabilities of the human with respect to the set of skills;
receive a request to perform a task, the task associated with at least one skill in the set of skills;
perform an evaluation of the request to perform the task based on the benchmarking dataset for the artificial intelligence model and the skill proficiency evaluation for the human; and
provide a recommendation indicating that the task should be performed by the artificial intelligence model or that the task should be performed by the human based on the evaluation.

9. The computer-readable storage medium of claim 8, wherein the instructions, when executed by the processing circuitry, cause the processing circuitry to perform the evaluation of the request to perform the task based on a cost associated with the artificial intelligence model.

10. The computer-readable storage medium of claim 8, wherein the instructions, when executed by the processing circuitry, cause the processing circuitry to perform the task using the artificial intelligence model when the recommendation indicates that the task should be performed by the artificial intelligence model.

11. The computer-readable storage medium of claim 8, wherein the instructions, when executed by the processing circuitry, cause the processing circuitry to prompt the human to perform the task via the user device when the recommendation indicates that the task should be performed by the human.

12. The computer-readable storage medium of claim 8, wherein the instructions, when executed by the processing circuitry, cause the processing circuitry to perform the evaluation of the request to perform the task based on a time commitment required of the human to perform the task.

13. The computer-readable storage medium of claim 8, wherein the instructions, when executed by the processing circuitry, cause the processing circuitry to perform the evaluation and provide the recommendation using agentic artificial intelligence without human prompting.

14. The computer-readable storage medium of claim 8, wherein the artificial intelligence model comprises a large language model (LLM).

15. A system comprising:
memory comprising machine-readable instructions; and
processing circuitry configured to execute the machine-readable instructions to:
provide an assessment dataset as input to an artificial intelligence model, the assessment dataset comprising a series of prompts associated with a set of skills;
generate a benchmarking dataset for the artificial intelligence model based on outputs generated by the artificial intelligence model responsive to receiving the assessment dataset as input, the benchmarking dataset indicative of performance capabilities of the artificial intelligence model with respect to the set of skills;
cause a skill proficiency assessment to be provided to a human via a user interface on a user device, the skill proficiency assessment comprising a series of questions associated with the set of skills;
generate a skill proficiency evaluation for the human based on answers provided by the human to the series of questions via the user interface on the user device, the skill proficiency assessment indicative of performance capabilities of the human with respect to the set of skills;
receive a request to perform a task, the task associated with at least one skill in the set of skills;
perform an evaluation of the request to perform the task based on the benchmarking dataset for the artificial intelligence model and the skill proficiency evaluation for the human; and
provide a recommendation indicating that the task should be performed by the artificial intelligence model or that the task should be performed by the human based on the evaluation.

16. The system of claim 15, wherein the processing circuitry is configured to execute the machine-readable instructions to perform the evaluation of the request to perform the task based on a cost associated with the artificial intelligence model.

17. The system of claim 15, wherein the processing circuitry is configured to execute the machine-readable instructions to perform the task using the artificial intelligence model when the recommendation indicates that the task should be performed by the artificial intelligence model.

18. The system of claim 15, wherein the processing circuitry is configured to execute the machine-readable instructions to prompt the human to perform the task via the user device when the recommendation indicates that the task should be performed by the human.

19. The system of claim 15, wherein the processing circuitry is configured to execute the machine-readable instructions to perform the evaluation of the request to perform the task based on a time commitment required of the human to perform the task.

20. The system of claim 15, wherein:
the series of prompts comprises at least one prompt submitted by a second human; and
the second human is associated with a proficiency level for at least one skill in the set of skills that exceeds a threshold proficiency level.
